(19) United States
(12) Patent Application Publication
(10) Pub. No.: US 2025/0297913 A1
(43) Pub. Date: Sep. 25, 2025

(54) Measurement Method, Measurement Apparatus, Measurement System, And Non-Transitory Computer-Readable Storage Medium Storing Measurement Program

(71) Applicant: SEIKO EPSON CORPORATION, Tokyo (JP)

(72) Inventor: Yoshihiro KOBAYASHI, Komagane (JP)

(21) Appl. No.: 19/088,085

(22) Filed: Mar. 24, 2025

(30) Foreign Application Priority Data
Mar. 25, 2024 (JP) 2024-048339

(51) Int. Cl. G01M 5/00; G01P 15/18

(52) U.S. Cl. CPC G01M 5/0008; G01M 5/0041; G01M 5/0066; G01P 15/18

(57) ABSTRACT

A measurement method includes: a step of calculating, based on displacement of a bridge obtained based on observation data of an observation point of the bridge, a provisional entry time and a provisional exit time of a railway vehicle with respect to the bridge; a step of calculating a deflection amount of the bridge caused by the railway vehicle, based on an approximate formula for deflection of the bridge, the provisional entry time, the provisional exit time, and environmental information created in advance; a step of calculating, based on the displacement and the deflection amount, an entry time correction value for correcting an error of the provisional entry time and an exit time correction value for correcting an error of the provisional exit time; and a step of calculating an entry time of the railway vehicle to the bridge by adding the entry time correction value to the provisional entry time, and calculating an exit time of the railway vehicle from the bridge by adding the exit time correction value to the provisional exit time.

The present application is based on, and claims priority from JP Application Serial Number 2024-048339, filed Mar. 25, 2024, the disclosure of which is hereby incorporated by reference herein in its entirety.

### BACKGROUND

### 1. Technical Field

The present disclosure relates to a measurement method, a measurement apparatus, a measurement system, and a non-transitory computer-readable storage medium storing a measurement program.

### 2. Related Art

JP-A-2019-049095 discloses an acceleration sensor mounted on a railway bridge and a deflection measurement apparatus that sets output of the acceleration sensor when the railway bridge is in an unloaded state as a zero point of an acceleration, corrects the zero point of the acceleration output from the acceleration sensor when the railway bridge is in a loaded state, and applies double integration, Bayesian estimation, a Kalman filter, or the like after the zero point correction to prevent drift and estimate a deflection amount of the railway bridge.

However, since the acceleration detected by the acceleration sensor provided at the bridge changes not only depending on a vibration generated by load application of each car of a railway vehicle but also depending on an environmental vibration or the like, there may not always be a clear change in the output of the acceleration sensor when the railway vehicle enters or exits the bridge. Therefore, the deflection measurement apparatus disclosed in JP-A-2019-049095 may not be capable of accurately calculating an entry time and an exit time of the railway vehicle with respect to the railway bridge.

### SUMMARY

An aspect of a measurement method according to the disclosure includes:
an observation data acquisition step of acquiring observation data output from an observation apparatus that observes an observation point of a bridge, the observation data including a response to an action of a railway vehicle traveling on the bridge on the observation point;
a provisional entry and exit time calculation step of calculating, based on displacement of the bridge obtained based on the observation data, a provisional entry time and a provisional exit time of the railway vehicle with respect to the bridge;
a deflection amount calculation step of calculating a deflection amount of the bridge caused by the railway vehicle, based on an approximate formula for deflection of the bridge, the provisional entry time, the provisional exit time, and environmental information including a dimension of the railway vehicle and a dimension of the bridge which are created in advance;
a correction value calculation step of calculating, based on the displacement and the deflection amount, an entry time correction value for correcting an error of the provisional entry time and an exit time correction value for correcting an error of the provisional exit time; and
an entry and exit time calculation step of calculating an entry time of the railway vehicle to the bridge by adding the entry time correction value to the provisional entry time, and calculating an exit time of the railway vehicle from the bridge by adding the exit time correction value to the provisional exit time.

An aspect of a measurement apparatus according to the disclosure includes:
an observation data acquisition unit configured to acquire observation data output from an observation apparatus that observes an observation point of a bridge, the observation data including a response to an action of a railway vehicle traveling on the bridge on the observation point;
a provisional entry and exit time calculation unit configured to calculate, based on displacement of the bridge obtained based on the observation data, a provisional entry time and a provisional exit time of the railway vehicle with respect to the bridge;
a deflection amount calculation unit configured to calculate a deflection amount of the bridge caused by the railway vehicle, based on an approximate formula for deflection of the bridge, the provisional entry time, the provisional exit time, and environmental information including a dimension of the railway vehicle and a dimension of the bridge which are created in advance;
a correction value calculation unit configured to calculate, based on the displacement and the deflection amount, an entry time correction value for correcting an error of the provisional entry time and an exit time correction value for correcting an error of the provisional exit time; and
an entry and exit time calculation unit configured to calculate an entry time of the railway vehicle to the bridge by adding the entry time correction value to the provisional entry time, and to calculate an exit time of the railway vehicle from the bridge by adding the exit time correction value to the provisional exit time.

An aspect of a measurement system according to the disclosure includes:
the aspect of the measurement apparatus; and
the observation apparatus.

An aspect of a non-transitory computer-readable storage medium storing a measurement program according to the disclosure causes a computer to execute
an observation data acquisition step of acquiring observation data output from an observation apparatus that observes an observation point of a bridge, the observation data including a response to an action of a railway vehicle traveling on the bridge on the observation point;
a provisional entry and exit time calculation step of calculating, based on displacement of the bridge obtained based on the observation data, a provisional entry time and a provisional exit time of the railway vehicle with respect to the bridge;
a deflection amount calculation step of calculating a deflection amount of the bridge caused by the railway vehicle, based on an approximate formula for deflection of the bridge, the provisional entry time, the provisional exit time, and environmental information including a dimension of the railway vehicle and a dimension of the bridge which are created in advance;
a correction value calculation step of calculating, based on the displacement and the deflection amount, an entry time correction value for correcting an error of the provisional entry time and an exit time correction value for correcting an error of the provisional exit time; and
an entry and exit time calculation step of calculating an entry time of the railway vehicle to the bridge by adding the entry time correction value to the provisional entry time, and calculating an exit time of the railway vehicle from the bridge by adding the exit time correction value to the provisional exit time.

### BRIEF DESCRIPTION OF THE DRAWINGS

FIG. 1 shows a configuration example of a measurement system according to a first embodiment.

FIG. 2 is a cross-sectional view of a superstructure in FIG. 1 taken along line A-A.

FIG. 3 shows an acceleration detected by an acceleration sensor.

FIG. 4 shows an example of an acceleration α(t) when a railway vehicle travels on a bridge.

FIG. 5 shows power spectral density obtained by performing fast Fourier transform processing on the acceleration α(t).

FIG. 6 shows an example of a gain-frequency characteristic of a high-pass filter.

FIG. 7 shows an example of relationships between a displacement waveform u_{α_hp}(t) and each of a provisional entry time t_{i_tmp} and a provisional exit time t_{o_tmp}.

FIG. 8 is an enlarged view of a period between the provisional entry time t_{i_tmp} and the provisional exit time t_{o_tmp} in the displacement waveform u_{α_hp}(t).

FIG. 9 shows an example of a length L_{C}(Cₘ) and an axle-to-axle distance La(a_{w}(Cₘ, n) of a car.

FIG. 10 shows a structural model of the bridge.

FIG. 11 shows an example of a deflection amount w_{std}(a_{w} (Cₘ, n), t).

FIG. 12 shows an example of a deflection amount C_{std}(Cₘ, t).

FIG. 13 shows an example of a deflection amount T_{std}(t).

FIG. 14 shows a relationship between the deflection amount T_{std}(t) and the deflection amount w_{std}(a_{w} (Cₘ, n), t).

FIG. 15 shows a deflection waveform u_{M_hp}(t) obtained by performing high-pass filter processing on the deflection amount T_{std}(t).

FIG. 16 shows relationships between each of the displacement waveform u_{α_hp}(t) and the deflection waveform u_{M_hp}(t), and each of an entry time correction value t_{i_cor} and an exit time correction value t_{o_cor}.

FIG. 17 shows relationships between displacement u_{α}(t) obtained by performing double integration on the acceleration α(t), and each of an entry time tᵢ and an exit time tₒ.

FIG. 18 is a flowchart showing an example of a procedure of a measurement method.

FIG. 19 is a flowchart showing an example of a procedure of a correction value calculation step in the first embodiment.

FIG. 20 shows a configuration example of a sensor, a measurement apparatus, and a monitoring apparatus.

FIG. 21 shows a configuration example of a measurement system according to a second embodiment.

FIG. 22 shows another configuration example of the measurement system according to the second embodiment.

FIG. 23 shows an example of displacement u_{d}(t).

FIG. 24 shows an example of relationships between the displacement u_{d}(t) and each of the provisional entry time t_{i_tmp} and the provisional exit time t_{o_tmp}.

FIG. 25 shows a relationship between the displacement u_{d}(t) and the deflection amount T_{std}(t).

FIG. 26 shows relationships between each of the displacement u_{d}(t) and a deflection waveform u_{M}(t), and each of the entry time correction value t_{i_cor} and the exit time correction value t_{o_cor}.

FIG. 27 is a flowchart showing an example of a procedure of a correction value calculation step in the second embodiment.

FIG. 28 shows an example of relationships between a displacement waveform u_{d_hp}(t) and each of the provisional entry time t_{i_tmp} and the provisional exit time t_{o_tmp} in a modification.

FIG. 29 shows relationships between each of the displacement waveform u_{d_hp}(t) and the deflection waveform u_{M_hp}(t), and each of the entry time correction value t_{i_cor} and the exit time correction value t_{o_cor} in the modification.

FIG. 30 shows relationships between the displacement u_{d}(t) and each of the entry time tᵢ and the exit time tₒ in the modification.

### DESCRIPTION OF EMBODIMENTS

Hereinafter, preferred embodiments of the disclosure will be described in detail with reference to the drawings. The embodiments to be described below do not unduly limit contents of the disclosure described in the claims. Not all configurations described below are necessarily essential components of the disclosure.

### 1. First Embodiment

### 1-1. Configuration of Measurement System

A weight of a railway vehicle passing a bridge is large and can be measured using BWIM. BWIM is an abbreviation for bridge weigh-in-motion, and is a technique for measuring the weight, the number of axles, and the like of the railway vehicle passing the bridge by treating the bridge as a “scale” and measuring deformation of the bridge. The bridge that can analyze the weight of the passing railway vehicle based on a response such as deformation or strain has a structure in which the BWIM functions, and a BWIM system that applies a physical process between an action on the bridge and the response enables the measurement of the weight of the passing railway vehicle.

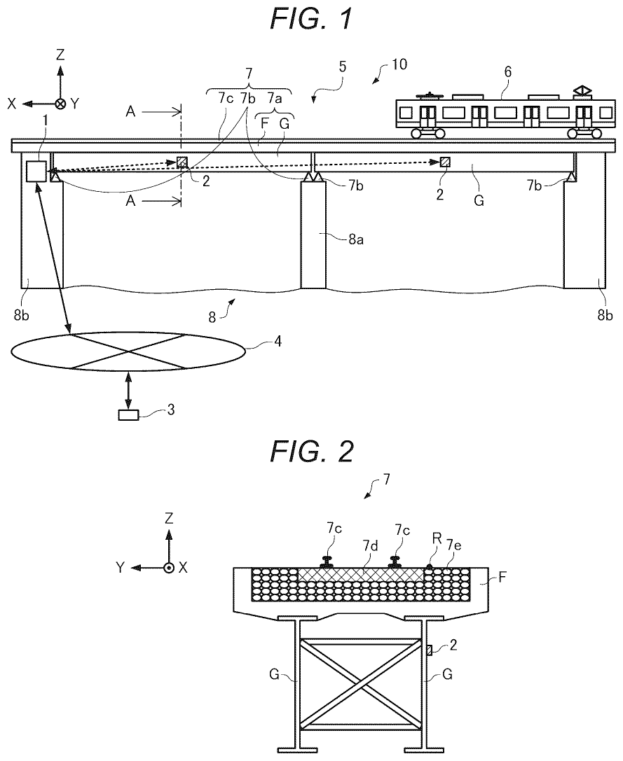

FIG. 1 shows an example of a measurement system according to an embodiment. As shown in FIG. 1, a measurement system 10 according to the embodiment includes a measurement apparatus 1, and at least one sensor 2 provided at a bridge 5. The measurement system 10 may further include a monitoring apparatus 3.

The bridge 5 includes a superstructure 7 and a substructure 8. FIG. 2 is a cross-sectional view of the superstructure 7 taken along line A-A in FIG. 1. As shown in FIGS. 1 and 2, the superstructure 7 includes a bridge deck 7a including a deck slab F, a main girder G, a cross girder (not shown), and the like, a bearing 7b, a rail 7c, a tie 7d, and a ballast 7e. As shown in FIG. 1, the substructure 8 includes a bridge pier 8a and a bridge abutment 8b. The superstructure 7 is a structure that spans across the bridge abutment 8b and the bridge pier 8a adjacent to each other, two adjacent bridge abutments 8b, or two adjacent bridge piers 8a. Both ends of the superstructure 7 are located at positions of the bridge abutment 8b and the bridge pier 8a adjacent to each other, at positions of the two adjacent bridge abutments 8b, or at positions of the two adjacent bridge piers 8a.

When railway a vehicle 6 enters the superstructure 7 of the bridge 5, the superstructure 7 deflects due to a load of the railway vehicle 6, and since the railway vehicle 6 has a plurality of coupled cars, the deflection of the superstructure 7 is periodically repeated as each car passes.

The measurement apparatus 1 and each sensor 2 are coupled by, for example, a cable (not shown), and communicate with each other via a communication network such as a CAN. CAN is an abbreviation for a controller area network. Alternatively, the measurement apparatus 1 and each sensor 2 may communicate with each other via a wireless network.

Each sensor 2 outputs observation data including a physical quantity generated when the railway vehicle 6 travels on the bridge 5. In the embodiment, each sensor 2 is an acceleration sensor, and the observation data is acceleration data including an acceleration generated when the railway vehicle 6 travels on the bridge 5. Each sensor 2 may be, for example, a quartz crystal acceleration sensor or a MEMS acceleration sensor. MEMS is an abbreviation for micro electro mechanical systems.

In the embodiment, each sensor 2 is provided at a central portion in a longitudinal direction of the superstructure 7 of the bridge 5, specifically, at a central portion in a longitudinal direction of the main girder G. However, each sensor 2 only needs to be capable of detecting the acceleration generated due to the traveling of the railway vehicle 6, and an installation position thereof is not limited to the central portion of the superstructure 7. When each sensor 2 is provided at the deck slab F of the superstructure 7, the sensor 2 may be broken due to the traveling of the railway vehicle 6 and measurement accuracy may be affected due to local deformation of the bridge deck 7a, and thus each sensor 2 is provided at the main girder G of the superstructure 7 in the example in FIGS. 1 and 2.

The deck slab F, the main girder G, and the like of the superstructure 7 deflect in a vertical direction due to the load of the railway vehicle 6 passing the bridge 5. Each sensor 2 detects an acceleration of the deflection of the deck slab F and the main girder G due to the load of the railway vehicle 6 passing the bridge 5.

Based on acceleration data output from each sensor 2, the measurement apparatus 1 calculates a passing speed of the railway vehicle 6 and displacement of the bridge 5 when the railway vehicle 6 passes the bridge 5. The measurement apparatus 1 is provided at, for example, the bridge abutment 8b.

The measurement apparatus 1 and the monitoring apparatus 3 can communicate with each other via, for example, a wireless network of a mobile phone and a communication network 4 such as the Internet. The measurement apparatus 1 transmits, to the monitoring apparatus 3, measurement data including the passing speed of the railway vehicle 6 and the displacement of the bridge 5 when the railway vehicle 6 passes the bridge 5. The monitoring apparatus 3 may store the measurement data in a storage apparatus (not shown) and perform processing such as monitoring of the railway vehicle 6 and abnormality determination of the superstructure 7 based on the measurement data.

In the embodiment, the bridge 5 is a railway bridge such as a steel bridge, a girder bridge, or an RC bridge. RC is an abbreviation for reinforced-concrete.

As shown in FIG. 2, in the embodiment, an observation point R is set in association with the sensor 2. In the example in FIG. 2, the observation point R is set at a position on a surface of the superstructure 7 located vertically above the sensor 2 provided at the main girder G. That is, the sensor 2 is an observation apparatus that observes the observation point R, detects a physical quantity that is a response to an action of a plurality of parts of the railway vehicle 6 traveling on the bridge 5 on the observation point R, and outputs observation data including the detected physical quantity. For example, each of the plurality of parts of the railway vehicle 6 is an axle or a wheel, and is hereinafter assumed to be the axle. In the embodiment, each sensor 2 is an acceleration sensor and detects an acceleration as the physical quantity. The sensor 2 only needs to be provided at a position where the acceleration generated at the observation point R due to the traveling of the railway vehicle 6 can be detected, and is desirably provided at a position close to vertically above the observation point R.

The number and the installation position of the sensor 2 are not limited to the example shown in FIGS. 1 and 2, and various modifications can be made.

Based on the acceleration data that is the observation data output from the sensor 2, the measurement apparatus 1 acquires an acceleration in a direction intersecting a surface of the superstructure 7 of the bridge 5 where the railway vehicle 6 travels. The surface of the superstructure 7 where the railway vehicle 6 travels is defined by a direction in which the railway vehicle 6 travels, that is, an X direction that is the longitudinal direction of superstructure 7, and a direction orthogonal to the direction in which the railway vehicle 6 travels, that is, a Y direction that is a width direction of the superstructure 7. Since the observation point R deflects in a direction orthogonal to the X direction and the Y direction due to the traveling of the railway vehicle 6, it is desirable that the measurement apparatus 1 acquires an acceleration in the direction orthogonal to the X direction and the Y direction, that is, a Z direction that is a normal direction of the deck slab F, in order to accurately calculate magnitude of the acceleration of the deflection.

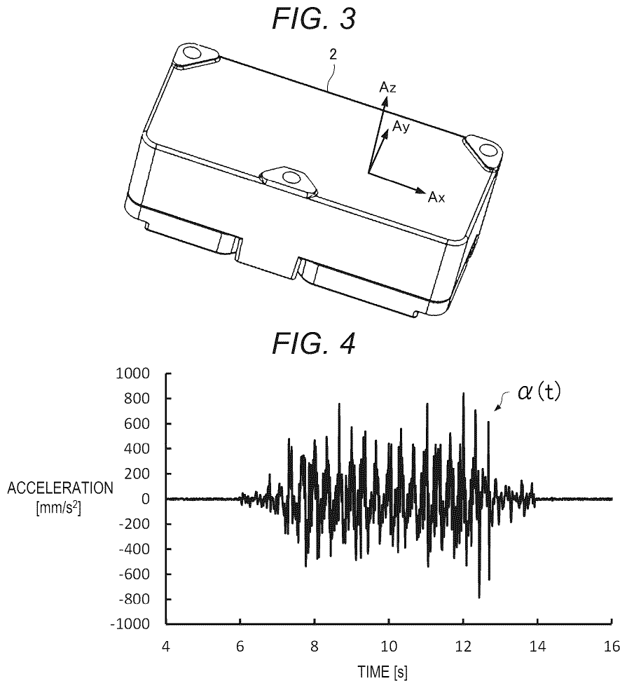

FIG. 3 shows the acceleration detected by the sensor 2. The sensor 2 is an acceleration sensor that detects the acceleration generated in each of three axes orthogonal to one another.

In order to detect the acceleration of the deflection of the observation point R caused by the traveling of the railway vehicle 6, the sensor 2 is provided such that one of an x-axis, a y-axis, and a z-axis, which are three detection axes, is in the direction intersecting the X direction and the Y direction. Since the observation point R deflects in the direction orthogonal to the X direction and the Y direction, in order to accurately detect the acceleration of deflection, ideally, the sensor 2 is provided such that one axis is aligned with the Z direction orthogonal to the X direction and the Y direction, that is, the normal direction of the deck slab F.

However, when the sensor 2 is provided at the superstructure 7, an installation location may be inclined. In the measurement apparatus 1, even when one of the three detection axes of the sensor 2 is not aligned with the normal direction of the deck slab F, since the axis is substantially oriented in the normal direction, an error is small and thus can be ignored. Even when one of the three detection axes of the sensor 2 is not aligned with the normal direction of the deck slab F, the measurement apparatus 1 can correct a detection error caused by inclination of the sensor 2 using a three-axis combined acceleration obtained by combining accelerations in the x-axis, the y-axis, and the z-axis. Alternatively, the sensor 2 may be a uniaxial acceleration sensor that at least detects an acceleration generated in a direction substantially parallel to the vertical direction or an acceleration in the normal direction of the deck slab F.

Hereinafter, details of a measurement method according to the embodiment performed by the measurement apparatus 1 will be described. In the following description, unless otherwise specified, the bridge 5 and the superstructure 7 are not distinguished on an assumption that the bridge 5 includes one superstructure 7. When the bridge 5 includes a plurality of superstructures 7, the following description holds by regarding each superstructure 7 to be measured, where the sensor 2 is provided, as one bridge 5.

### 1-2. Details of Measurement Method

In the embodiment, the measurement apparatus 1 calculates an entry time tᵢ and an exit time tₒ of the railway vehicle 6 with respect to the bridge 5 based on the acceleration data output from the sensor 2, environmental information including a dimension of the railway vehicle 6 and a dimension of the bridge 5 which are created in advance, and a structural model of the superstructure 7 of the bridge 5.

### 1-2-1. Calculation of Provisional Entry and Exit Time

First, the measurement apparatus 1 calculates a provisional entry time t_{i_tmp} and a provisional exit time t_{o_tmp} of the railway vehicle 6 with respect to the bridge 5 based on the acceleration data output from the sensor 2.

When the railway vehicle 6 travels on the bridge 5, an acceleration is generated at the observation point R in a gravitational acceleration direction. The sensor 2 detects the acceleration as acceleration α(k) in the z-axis direction, and outputs the acceleration data including the acceleration α(k) in time series. Here, k is a sample number. When a sample time interval is ΔT, the time series of the acceleration α(k) is converted into an acceleration α(t) having a time t as a variable, where the time t=KΔT. FIG. 4 shows an example of the acceleration α(t) when the railway vehicle 6 travels on the bridge 5.

The measurement apparatus 1 acquires the acceleration data output from the sensor 2 and performs double integration on the acceleration α(t) in the acceleration data to calculate displacement u_{α}(t) as in Formula (1).

$$Math . 1$$

$${u}_{α} ( t ) = \int \int α ( t ) dt \qquad ( 1 )$$

Since the displacement u₆₀ (t)) includes drift noise and a bias offset error in a low-frequency range, the measurement apparatus 1 calculates a displacement waveform u_{α_hp}(t) obtained by performing high-pass filter processing on the displacement u_{α}(t) in order to reduce the drift noise and the offset error.

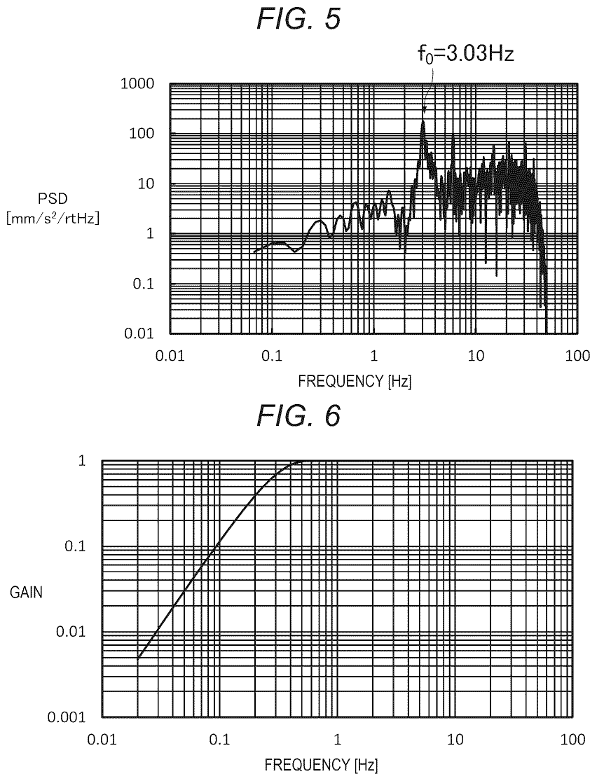

Specifically, first, the measurement apparatus 1 performs fast Fourier transform processing on the acceleration α(t) to calculate power spectral density, and calculates a frequency of a peak having lowest power spectral density as a fundamental frequency f₀. The fundamental frequency f₀ corresponds to a reciprocal of a cycle of load application to the bridge 5 by each car when the railway vehicle 6 passes the bridge 5. FIG. 5 shows the power spectral density obtained by performing the fast Fourier transform processing on the acceleration α(t) in FIG. 4. In the example in FIG. 5, the fundamental frequency f₀ is calculated as 3.03 Hz.

The measurement apparatus 1 calculates the displacement waveform u_{α_hp}(t) obtained by performing the high-pass filter processing on the displacement u_{α}(t) using a high-pass filter having a frequency sufficiently lower than the fundamental frequency f₀ as a cutoff frequency f_{C}. FIG. 6 shows an example of a gain-frequency characteristic of such a high-pass filter. In the example in FIG. 6, the cutoff frequency f_{C} is a frequency in the vicinity of 0.3 Hz, and the fundamental frequency f₀ of 3.03 Hz is in a passband where a gain is 1.

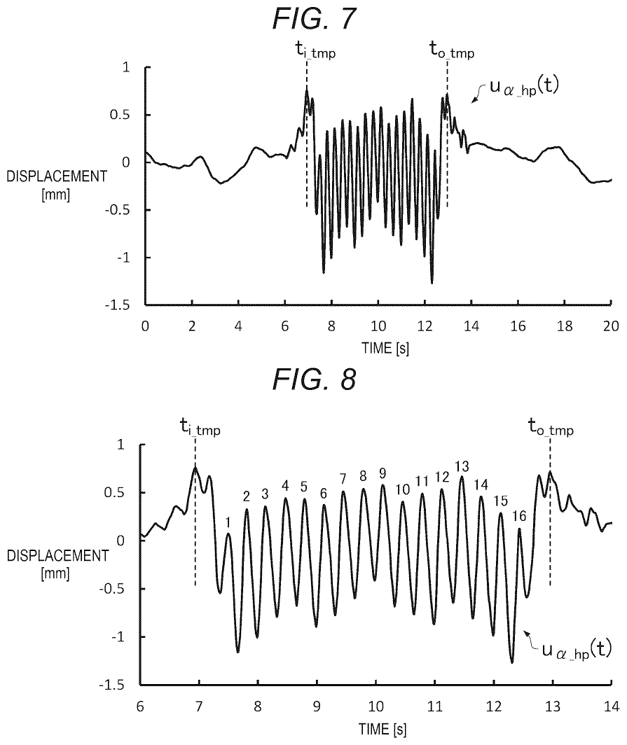

The measurement apparatus 1 calculates a time of a first peak and a time of a last peak of a vibration of the displacement waveform u_{α_hp}(t) generated when the railway vehicle 6 passes the bridge 5 as the provisional entry time t_{i_tmp} and the provisional exit time t_{o_tmp} of the railway vehicle 6 with respect to the bridge 5, respectively. FIG. 7 shows an example of relationships between the displacement waveform u_{α_hp}(t) and each of the provisional entry time t_{i_tmp} and the provisional exit time t_{o_tmp}.

Further, the measurement apparatus 1 calculates a provisional passing time t_{S_tmp} required for the railway vehicle 6 to pass the bridge 5 as a time of a difference between the provisional exit time t_{o_tmp} and the provisional entry time t_{i_tmp} as in Formula (2).

$$Math . 2$$

$${t}_{s \_ temp} = {t}_{o \_ tmp} - {t}_{i \_ tmp} \qquad ( 2 )$$

The measurement apparatus 1 can calculate the number of cars C_{T} of the railway vehicle 6 based on the provisional passing time t_{S_tmp} and the fundamental frequency f₀ using Formula (3).

$$Math . 3$$

$${C}_{T} = \vert {t}_{s \_ temp} {f}_{0} - 1 \vert \qquad ( 3 )$$

Alternatively, the measurement apparatus 1 may calculate the number of cars C_{T} by counting the number of vibrations in a period between the provisional entry time t_{i_tmp} and the provisional exit time t_{o_tmp} in the displacement waveform u_{α_hp}(t). FIG. 8 is an enlarged view of the period between the provisional entry time t_{i_tmp} and the provisional exit time t_{o_tmp} in the displacement waveform u_{α_hp}(t) shown in FIG. 7. In the example in FIG. 8, the number of vibrations of the displacement waveform u_{α_hp}(t) is 16, and 16 is calculated as the number of cars C_{T}.

When the number of cars C_{T} is not changed by the railway vehicle 6 passing the bridge 5, the measurement apparatus 1 does not need to calculate the number of cars C_{T} based on the acceleration data output from the sensor 2, and thus, for example, the number of cars C_{T} may be provided in the environmental information.

### 1-2-2. Calculation of Deflection Amount

Next, the measurement apparatus 1 calculates a deflection amount T_{std}(t) of the bridge 5 caused by the railway vehicle 6, based on a structural model of the bridge 5 and the environmental information including the dimension of the railway vehicle 6 and the dimension of the bridge 5 which are created in advance.

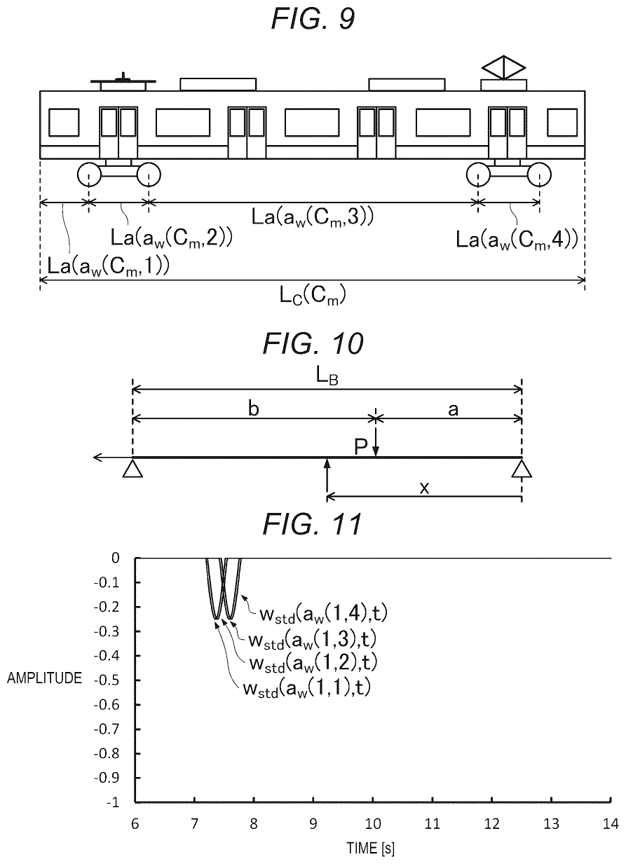

The environmental information includes, as the dimension of the bridge 5, for example, a bridge length L_{B} and a position Lx of the observation point R. The bridge length L_{B} is a length of the bridge 5, and in the embodiment, is a distance between an entry end and an exit end of the superstructure 7. For example, when the bridge 5 includes a plurality of superstructures 7, the bridge length L_{B} is a distance between the entry end and the exit end of each superstructure 7 to be measured. The position Lₓ of the observation point R is a distance from the entry end of the superstructure 7 to the observation point R. The environmental information includes, as the dimension of the railway vehicle 6, for example, a length L_{C}(Cₘ) of each car of the railway vehicle 6, the number of axles a_{T}(Cₘ) of each car, and an axle-to-axle distance La(a_{w}(Cₘ, n)) of each car. Here, Cₘ is a car number, and the length L_{C}(Cₘ) of each car is a distance between both ends of a Cₘ-th car from the front. The number of axles a_{T}(Cₘ) of each car is the number of axles of the Cₘ-th car from the front. Here, n is an axle number of each car and satisfies 1≤n≤a_{T}(Cₘ). The axle-to-axle distance La(a_{w}(Cₘ, n) of each car is a distance between a front end of the Cₘ-th car from the front and a first axle from the front when n=1, and is a distance between an (n−1)-th axle and an n-th axle from the front when n≥2. FIG. 9 shows an example of the length L_{C}(Cₘ) and the axle-to-axle distance La(a_{w}(Cₘ, n)) of the Cₘ-th car of the railway vehicle 6. The dimension of the railway vehicle 6 and a dimension of the superstructure 7 can be measured using a known method. A database of the dimension of the railway vehicle 6 passing the bridge 5 may be created in advance, and a dimension of a corresponding car may be referred to based on a passing time.

When it is assumed that the railway vehicle 6 to which any number of cars having the same dimension are coupled travels on the superstructure 7 of the bridge 5, the environmental information may include, for one car, the length L_{C}(Cₘ) of the car, the number of axles a_{T}(Cₘ) of the car, and the axle-to-axle distance La(a_{w}(Cₘ, n).

A total number of axles Tar of the railway vehicle 6 is calculated by Formula (4) using the number of cars C_{T} of the railway vehicle 6 and the number of axles a_{T}(Cₘ) of each car provided in the environmental information.

$$Math . 4$$

$${Ta}_{T} = {\sum }_{{C}_{m} = 1}^{{C}_{T}} {a}_{T} ( {C}_{m} ) \qquad ( 4 )$$

A distance D_{wa}(a_{w} (Cₘ, n) from a first axle of the railway vehicle 6 to the n-th axle of the Cₘ-th car is calculated by Formula (5) using the length L_{C}(Cₘ) of each car, the number of axles a_{T}(Cₘ) of each car, and the axle-to-axle distance La(a_{w}(Cₘ, n)) of each car provided in the environmental information. In Formula (5), it is assumed that L_{C}(Cₘ)=L_{C}(1).

$$Math . 5$$

$${D}_{wa} ( {a}_{w} ( {C}_{m} , n ) ) = {\sum }_{y = 1}^{{C}_{m}} {L}_{C} ( y ) + {\sum }_{x = 1}^{n} La ( {a}_{w} ( {C}_{m} , x ) ) - \{ {L}_{C} ( 1 ) + La ( {a}_{w} ( 1 , 1 ) ) \} \qquad ( 5 )$$

A distance D_{wa}(a_{w} (C_{T}, a_{T}(C_{T}))) from the first axle of the railway vehicle 6 to a last axle of a last car is calculated by Formula (6) assuming that Cₘ=C_{T} and n=a_{T}(C_{T}) in Formula (5).

$$Math . 6$$

$${D}_{wa} ( {a}_{w} ( {C}_{T} , {a}_{T} ( {C}_{T} ) ) ) = {\sum }_{y = 1}^{{C}_{T}} {L}_{C} ( y ) + {\sum }_{x = 1}^{{a}_{T} ( {C}_{T} )} La ( {a}_{w} ( {C}_{T} , x ) ) - \{ {L}_{C} ( 1 ) + La ( {a}_{w} ( 1 , 1 ) ) \} \qquad ( 6 )$$

An average speed vₐ of the railway vehicle 6 is calculated by Formula (7) using the provisional passing time t_{S_tmp} calculated by Formula (2) described above, the bridge length L_{B} provided in the environmental information, and the distance D_{wa}(a_{w} (C_{T}, a_{T}(C_{T}))).

$$Math . 7$$

$${v}_{a} = \frac{{L}_{B}}{{t}_{s \_ tmp}} + \frac{{D}_{wa} ( {a}_{w} ( {C}_{T} , {a}_{T} ( {C}_{T} ) ) )}{{t}_{s \_ tmp}} \qquad ( 7 )$$

The average speed vₐ of the railway vehicle 6 is calculated by Formula (8) obtained by substituting Formula (6) into Formula (7).

$$Math . 8$$

$${v}_{a} = \frac{{L}_{B}}{{t}_{s \_ tmp}} + \frac{1}{{t}_{s \_ tmp}} [ {\sum }_{y = 1}^{{C}_{T}} {L}_{C} ( y ) + {\sum }_{x = 1}^{{a}_{T} ( {C}_{T} )} La ( {a}_{w} ( {C}_{T} , x ) ) - \{ {L}_{C} ( 1 ) + La ( {a}_{w} ( 1 , 1 ) ) \} ] \qquad ( 8 )$$

In the embodiment, the superstructure 7 of the bridge 5 is considered as a configuration in which one or a plurality of bridge decks 7a each including the deck slab F, the main girder G, and the like are continuously disposed, and displacement of one bridge deck 7a is displacement of the central portion in the longitudinal direction. A load applied to the superstructure 7 moves from one end to the other end of the superstructure 7. At this time, a position of the load on the superstructure 7 and a load amount can be used to express a deflection amount that is the displacement of the central portion of the superstructure 7. In the embodiment, in order to express deflection deformation when the axle of the railway vehicle 6 moves on the superstructure 7 as a trajectory of the deflection amount due to movement of a one-point load on a beam, a structural model shown in FIG. 10 is considered, and the deflection amount of an intermediate portion is calculated in the structural model. In FIG. 10, P is the load. In addition, a is a load position from the entry end of the superstructure 7 on a side where the railway vehicle 6 enters. In addition, b is a load position from the exit end of the superstructure 7 on a side where the railway vehicle 6 exits. The structural model shown in FIG. 10 is a simple beam whose two ends are supported with the two ends acting as support points.

In the structural model shown in FIG. 10, when a position of the entry end of the superstructure 7 is set as zero and the observation position for the deflection amount is x, a bending moment M of the simple beam is expressed by Formula (9).

$$\begin{matrix}Math . 9 & \\ M = \frac{b}{{L}_{B}} Px - {PH}_{a} ( x - a ) & ( 9 )\end{matrix}$$

In Formula (9), a function Hₐ is defined as in Formula (10).

$$\begin{matrix}Math . 10 & \\ {H}_{a} = \{ \begin{matrix}0 & ( if x \leq a ) \\ 1 & ( if x > a )\end{matrix} & ( 10 )\end{matrix}$$

Formula (11) is obtained by transforming Formula (9).

$$\begin{matrix}Math . 11 & \\ - \frac{{ML}_{B}}{P} = - bx + {H}_{a} {L}_{B} ( x - a ) & ( 11 )\end{matrix}$$

Meanwhile, the bending moment M is expressed using Formula (12). In Formula (12), θ is an angle, I is a second moment, and E is a Young's modulus.

$$\begin{matrix}Math . 12 & \\ - M = EI \frac{d θ}{dx} & ( 12 )\end{matrix}$$

Formula (13) is obtained by substituting Formula (12) into Formula (11).

$$\begin{matrix}Math . 13 & \\ \frac{{EIL}_{B}}{P} \frac{d θ}{dx} = - bx + {H}_{a} {L}_{B} ( x - a ) & ( 13 )\end{matrix}$$

By integrating Formula (13) with respect to an observation position x, Formula (14) is calculated and Formula (15) is obtained. In Formula (15), C₁ is a constant of integration.

$$\begin{matrix}Math . 14 & \\ \int \frac{{EIL}_{B}}{P} \frac{d θ}{dx} dx = \int ( - bx + {H}_{a} {L}_{B} ( x - a ) ) dx & ( 14 )\end{matrix}$$

$$\begin{matrix}Math . 15 & \\ \frac{{EIL}_{B}}{P} θ = - \frac{{bx}^{2}}{2} + {H}_{a} \frac{{{L}_{B} ( x - a )}^{2}}{2} + {C}_{1} & ( 15 )\end{matrix}$$

Further, by integrating Formula (15) with respect to the observation position x, Formula (16) is calculated and Formula (17) is obtained. In Formula (17), C₂ is a constant of integration.

$$\begin{matrix}Math . 16 & \\ \int \frac{{EIL}_{B}}{P} θ dx = \int \{ - \frac{{bx}^{2}}{2} + {H}_{a} \frac{{{L}_{B} ( x - a )}^{2}}{2} + {C}_{1} \} dx & ( 16 )\end{matrix}$$

$$\begin{matrix}Math . 17 & \\ \frac{{EIL}_{B}}{P} θ x = - \frac{{bx}^{3}}{6} + {H}_{a} \frac{{{L}_{B} ( x - a )}^{2}}{6} + {C}_{1} x + {C}_{2} & ( 17 )\end{matrix}$$

In Formula (17), θx represents the deflection amount, and Formula (18) is obtained by replacing θx with a deflection amount w.

$$\begin{matrix}Math . 18 & \\ \frac{{EIL}_{B}}{P} w = - \frac{{bx}^{3}}{6} + {H}_{a} \frac{{{L}_{B} ( x - a )}^{3}}{6} + {C}_{1} x + {C}_{2} & ( 18 )\end{matrix}$$

Based on FIG. 10, since b=L_{B}−a, Formula (18) is transformed into Formula (19).

$$\begin{matrix}Math . 19 & \\ \frac{{EIL}_{B}}{P} w = - \frac{( {L}_{B} - a ) {x}^{3}}{6} + {H}_{a} \frac{{{L}_{B} ( x - a )}^{3}}{6} + {C}_{1} x + {C}_{2} & ( 19 )\end{matrix}$$

Since Hₐ=0 when x≤a assuming that the deflection amount w=0 at x=0, Formula (20) is obtained by substituting x=w=Hₐ=0 into Formula (19) and arranging.

$$\begin{matrix}Math . 20 & \\ {C}_{2} = 0 & ( 20 )\end{matrix}$$

Since Hₐ=1 when x>a assuming that the deflection amount w=0 at x=L_{B}, Formula (21) is obtained by substituting x=L_{B}, W=0, and Hₐ=1 into Formula (19) and arranging.

$$\begin{matrix}Math . 21 & \\ {C}_{1} = \frac{a ( {L}_{B} - a ) ( a + 2 ( {L}_{B} - a ) )}{6} & ( 21 )\end{matrix}$$

Formula (22) is obtained by substituting b=L_{B}−a into Formula (21).

$$\begin{matrix}Math . 22 & \\ {C}_{1} = \frac{ab ( a + 2 b )}{6} & ( 22 )\end{matrix}$$

Formula (23) is obtained by substituting the constant of integration C₁ in Formula (21) and the constant of integration C₂ in Formula (20) into Formula (18).

$$\begin{matrix}Math . 23 & \\ \frac{{EIL}_{B}}{P} w = - \frac{{bx}^{3}}{6} + {H}_{a} \frac{{{L}_{B} ( x - a )}^{3}}{6} + \frac{ab ( a + 2 b )}{6} x & ( 23 )\end{matrix}$$

Formula (23) is transformed and the deflection amount w at the observation position x when a load P is applied to a position a is expressed by Formula (24).

$$\begin{matrix}Math . 24 & \\ w = \frac{P}{6 {EIL}_{B}} \{ - {bx}^{3} + {H}_{a} {{L}_{B} ( x - a )}^{3} + ab ( a + 2 b ) x \} & ( 24 )\end{matrix}$$

A deflection amount w_{0.5LB} at the central observation position x when the load P is at the center of the superstructure 7 is expressed by Formula (25) assuming that x=0.5 L_{B}, a=b=0.5 L_{B}, and Hₐ=0. This deflection amount w_{0.5LB} is a maximum amplitude of the deflection amount w.

$$\begin{matrix}Math . 25 & \\ {w}_{0.5 {L}_{B}} = \frac{P}{48 EI} {L}_{B}^{3} & ( 25 )\end{matrix}$$

The deflection amount w at any observation position x is normalized by the deflection amount w_{0.5LB}. When the position a of the load P is closer to the entry end than the observation position x, when x>a, Formula (26) is obtained by substituting Hₐ=1 into Formula (24).

$$Math . 26$$

$$W = \frac{P}{6 {EIL}_{B}} \{ - {bx}^{3} + {{L}_{B} ( x - a )}^{3} + ab ( a + 2 b ) x \} \qquad ( 26 )$$

When the position a of the load P is a=L_{B}r, and a=L_{B}r and b=L_{B} (1−r) are substituted into Formula (26) and arranged, a deflection amount w_{std} obtained by normalizing the deflection amount w is obtained from Formula (27). Here, r represents a ratio of the position a of the load P to the bridge length L_{B}.

$$Math . 27$$

$${w}_{std} = \frac{8}{{L}_{B}} \{ {xr}^{3} + ( \frac{{x}^{3}}{{L}_{B}^{2}} + 2 x ) r \} - \frac{8}{{L}_{B}} ( {L}_{B} {r}^{3} + \frac{3 {x}^{2}}{{L}_{B}} r ) \qquad ( 27 )$$

Similarly, when the position a of the load P is closer to the exit end than the observation position x, when x≤a, Formula (28) is obtained by substituting Hₐ=0 into Formula (24).

$$Math . 28$$

$$W = \frac{P}{6 {EIL}_{B}} \{ - {bx}^{3} + ab ( {L}_{B} + b ) x \} \qquad ( 28 )$$

When the position a of the load P is a=L_{B}r, and a=L_{B}r and b=L_{B} (1−r) are substituted into Formula (28) and arranged, the deflection amount w_{std} obtained by normalizing the deflection amount w is obtained from Formula (29).

$$Math . 29$$

$${w}_{std} = \frac{8}{{L}_{B}} \{ {xr}^{3} + ( \frac{{x}^{3}}{{L}_{B}^{2}} + 2 x ) r \} - \frac{8}{{L}_{B}} ( 3 {xr}^{2} + \frac{{x}^{3}}{{L}_{B}^{2}} ) \qquad ( 29 )$$

By combining Formula (27) and Formula (29), a deflection amount w_{std}(r) at any observation position x=Lₓ is expressed by Formula (30). In Formula (30), a function R(r) is expressed by Formula (31). Formula (30) is an approximate formula for the deflection of the bridge 5 and is a formula based on the structural model of the bridge 5. Specifically, Formula (30) is an approximate formula normalized by a maximum amplitude of deflection at a central position between the entry end and the exit end of the superstructure 7.

$$Math . 30$$

$${w}_{std} ( r ) = \frac{8}{{L}_{B}} \{ {L}_{x} {r}^{3} + ( \frac{{L}_{x}^{3}}{{L}_{B}^{2}} + 2 {L}_{x} ) r - R ( r ) \} \qquad ( 30 )$$

$$Math . 31$$

$$R ( r ) = \{ \begin{matrix}{L}_{B} {r}^{3} + \frac{3 {L}_{x}^{2}}{{L}_{B}} r & ( if {L}_{x} > {L}_{B} r ) \\ 3 {L}_{x} {r}^{2} + \frac{{L}_{x}^{3}}{{L}_{B}^{2}} & ( if {L}_{x} \leq {L}_{B} r )\end{matrix} \qquad ( 31 )$$

In the embodiment, the load P is a load of any axle of the railway vehicle 6. A time tₓₙ required for any axle of the railway vehicle 6 to reach the position Lₓ of the observation point R from the entry end of the superstructure 7 is calculated by Formula (32) using the average speed vₐ calculated by Formula (8).

$$Math . 32$$

$${t}_{xn} = \frac{{L}_{x}}{{v}_{a}} \qquad ( 32 )$$

A time tₗₙ required for any axle of the railway vehicle 6 to pass the superstructure 7 having the length L_{B} is calculated by Formula (33).

$$Math . 33$$

$${t}_{ln} = \frac{{L}_{B}}{{v}_{a}} \qquad ( 33 )$$

A time t₀(Cₘ, n) when the n-th axle of the Cₘ-th car of the railway vehicle 6 reaches the entry end of the superstructure 7 is calculated by Formula (34) using the entry time tᵢ provided in observation information, the distance D_{wa}(a_{w} (Cₘ, n)) calculated by Formula (5), and the average speed vₐ calculated by Formula (8).

$$Math . 34$$

$${t}_{0} ( {C}_{m} , n ) = {t}_{i} + \frac{1}{{v}_{A}} {D}_{wa} ( {a}_{w} ( {C}_{m} , n ) ) \qquad ( 34 )$$

Using Formula (32), Formula (33), and Formula (34), a deflection amount w_{std}(a_{w} (Cₘ, n), t) obtained by replacing the deflection amount w_{std}(r) represented by Formula (30) caused by the n-th axle of the Cₘ-th car with a time is calculated by Formula (35). In Formula (35), a function R (t) is expressed by Formula (36). FIG. 11 shows examples of deflection amounts w_{std}(a_{w} (1, 1), t) to w_{std}(a_{w} (1, 4), t) caused by first to fourth axles of a first car.

$$Math . 35$$

$$\text{?} \qquad ( 35 )$$

$$Math . 36$$

$$\text{?} \qquad ( 36 )$$

$$\text{?} \text{indicates text missing or illegible when filed}$$

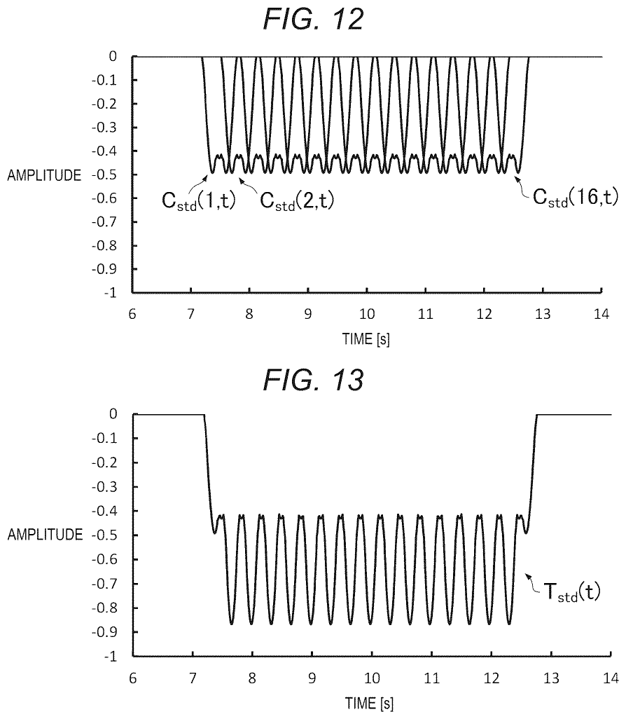

A deflection amount C_{std}(Cₘ, t) caused by the Cₘ-th car is calculated by Formula (37). FIG. 12 shows deflection amounts C_{std}(1, t) to C_{std}(16, t) caused by the railway vehicle 6 having the number of cars C_{T}=16.

$$Math . 37$$

$${C}_{std} ( {C}_{m} , t ) = {\sum }_{n = 1}^{{a}_{T} ( {C}_{m} )} {w}_{std} ( {a}_{w} ( {C}_{m} , n ) , t ) \qquad ( 37 )$$

Further, the deflection amount T_{std}(t) caused by the railway vehicle 6 is calculated by Formula (38). FIG. 13 shows an example of the deflection amount T_{std}(t) caused by the railway vehicle 6 having the number of cars C_{T}=16.

$$Math . 38$$

$${T}_{std} ( t ) = {\sum }_{{C}_{m} = 1}^{{C}_{T}} {C}_{std} ( {C}_{m} , t ) \qquad ( 38 )$$

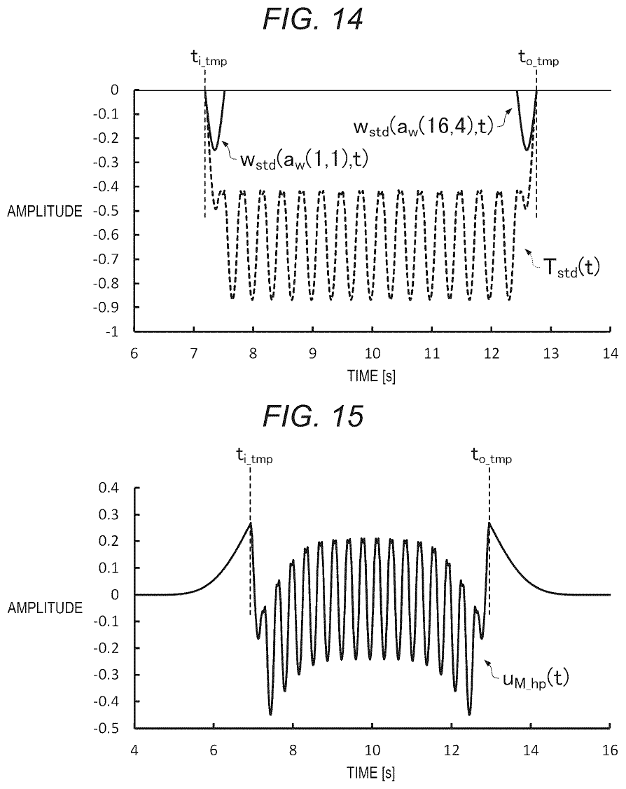

When the entry time tᵢ is a time when a first axle of a first car of the railway vehicle 6 enters the bridge 5 and the exit time tₒ is a time when a last axle of a last car of the railway vehicle 6 exits the bridge 5, the entry time tᵢ and the exit time tₒ respectively follow a first downward slope and a last upward slope of the deflection amount T_{std}(t). For example, as shown in FIG. 14, in the deflection amount T_{std}(t) shown in FIG. 13, the first downward slope is formed by a downward slope of the deflection amount w_{std}(a_{w} (1, 1), t) caused by the first axle of the first car, and the last upward slope is formed by an upward slope of a deflection amount w_{std}(a_{w} (16, 4), t) caused by a fourth axle of a sixteenth car. Therefore, the entry time tᵢ and the exit time tₒ are obtained by measuring a time of the first downward slope and a time of the last upward slope of the deflection amount T_{std}(t).

### 1-2-3. Calculation of Entry and Exit Time

The measurement apparatus 1 calculates a deflection waveform u_{M_hp}(t) obtained by performing high-pass filter processing on the deflection amount T_{std}(t), and compares the deflection waveform u_{M_hp}(t) with the displacement waveform u_{α_hp}(t) to calculate the entry time tᵢ and the exit time tₒ. As described above, the displacement waveform u_{α_hp}(t) is a waveform of displacement obtained by performing the high-pass filter processing on the displacement u_{α}(t). For the high-pass filter processing on the deflection amount T_{std}(t), the same high-pass filter as that used for the high-pass filter processing on the displacement u_{α}(t) is used. FIG. 15 shows the deflection waveform u_{M_hp}(t) obtained by performing the high-pass filter processing on the deflection amount T_{std}(t) shown in FIG. 13.

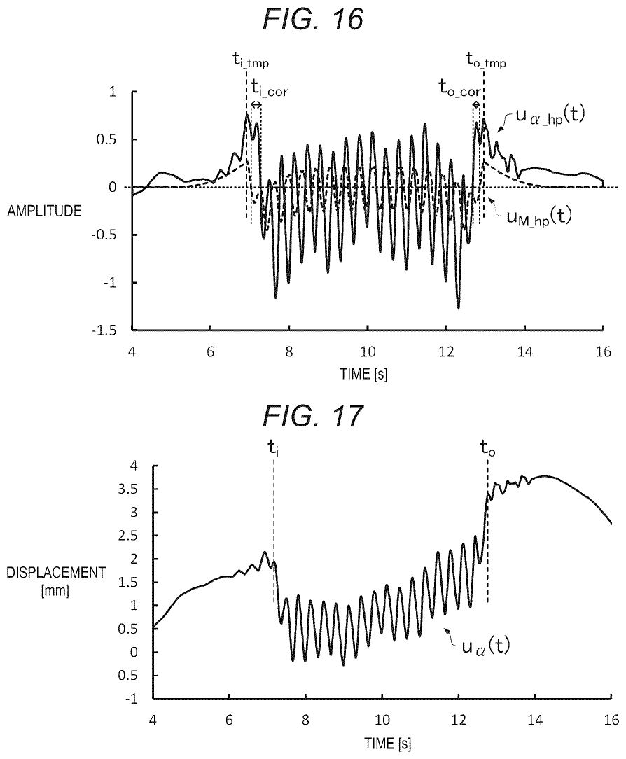

The measurement apparatus 1 calculates, as an entry time correction value t_{i_cor}, a difference between a time when an amplitude of the displacement waveform u_{α_hp}(t) first changes from positive to negative and a time when an amplitude of the deflection waveform u_{M_hp}(t) first changes from positive to negative in the period between the provisional entry time t_{i_tmp} and the provisional exit time t_{o_tmp}. The measurement apparatus 1 also calculates, as an exit time correction value t_{o_cor}, a difference between a time when the amplitude of the displacement waveform u_{α_hp}(t) last changes from negative to positive and a time when the amplitude of the deflection waveform u_{M_hp}(t) last changes from negative to positive in the period between the provisional entry time t_{i_tmp} and the provisional exit time t_{o_tmp}. FIG. 16 shows relationships between each of the displacement waveform u_{α_hp}(t) shown in FIG. 7 and the deflection waveform u_{M_hp}(t) shown in FIG. 15, and each of the entry time correction value t_{i_cor} and the exit time correction value t_{o_cor}.

The measurement apparatus 1 calculates the entry time tᵢ by adding the provisional entry time t_{i_tmp} and the entry time correction value t_{i_cor} as in Formula (39). The measurement apparatus 1 also calculates the exit time tₒ by adding the provisional exit time t_{o_tmp} and the exit time correction value t_{o_cor} as in Formula (40). FIG. 17 shows relationships between the displacement u_{α}(t) obtained by performing double integration on the acceleration α(t), and each of the entry time tᵢ and the exit time tₒ. As shown in FIG. 17, the entry time tᵢ and the exit time tₒ at times different from a characteristic point of the displacement u_{α}(t) are accurately calculated.

$$Math . 39$$

$${t}_{i} = {t}_{i \_ tmp} + {t}_{i \_ cor} \qquad ( 39 )$$

$$Math . 40$$

$${t}_{o} = {t}_{o \_ tmp} + {t}_{o \_ cor} \qquad ( 40 )$$

Further, the measurement apparatus 1 may calculate a passing time t_{S} required for the railway vehicle 6 to pass the bridge 5 as a time of a difference between the exit time tₒ and the entry time tᵢ as in Formula (41), and calculate an average speed v_{avg}, which is the passing speed of the railway vehicle 6 through the bridge 5, by Formula (42) using the calculated passing time t_{S}.

$$Math . 41$$

$${t}_{S} = {t}_{o} - {t}_{i} \qquad ( 41 )$$

$$Math . 42$$

$${v}_{avg} = \frac{{L}_{B} + {D}_{wa} ( {a}_{w} ( {C}_{T} , {a}_{T} ( {C}_{T} ) ) )}{{t}_{s}} \qquad ( 42 )$$

### 1-3. Procedure of Measurement Method

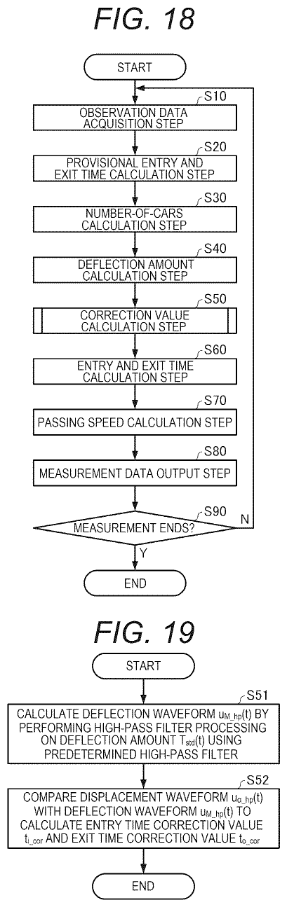

FIG. 18 is a flowchart showing an example of a procedure of the measurement method according to the first embodiment. In the embodiment, the measurement apparatus 1 performs the procedure shown in FIG. 18.

As shown in FIG. 18, first, in an observation data acquisition step S10, the measurement apparatus 1 acquires the observation data output from the sensor 2 that is the observation apparatus. The observation data includes the response to the action of the railway vehicle 6 traveling on the bridge 5 on the observation point R. In the embodiment, the sensor 2 is an acceleration sensor provided at the bridge 5, and the observation data is acceleration data including an acceleration as the response.

Next, in a provisional entry and exit time calculation step S20, the measurement apparatus 1 calculates the provisional entry time t_{i_tmp} and the provisional exit time t_{o_tmp} of the railway vehicle 6 with respect to the bridge 5 based on displacement of the bridge 5 obtained based on the acceleration data that is the observation data acquired in step S10. Specifically, first, the measurement apparatus 1 performs the fast Fourier transform processing on the acceleration α(t) provided in the acceleration data to calculate the power spectral density, and calculates the frequency of the peak having the lowest power spectral density as the fundamental frequency f₀. Next, the measurement apparatus 1 performs the double integration on the acceleration α(t) to calculate the displacement u_{α}(t) as in Formula (1) described above. Next, the measurement apparatus 1 performs the high-pass filter processing on the displacement u_{α}(t) using a predetermined high-pass filter to calculate the displacement waveform u_{α_hp}(t). The cutoff frequency f_{C} of the high-pass filter is lower than the fundamental frequency f₀ of a vibration of the bridge 5 caused by traveling of the railway vehicle 6 on the bridge 5. Therefore, the measurement apparatus 1 can calculate the displacement waveform u_{α_hp}(t) with reduced drift noise and a reduced offset error in a low-frequency range by the high-pass filter processing without reducing the fundamental frequency f₀ of the vibration of the bridge 5.

The measurement apparatus 1 calculates the time of the first peak and the time of the last peak of the vibration of the displacement waveform u_{α_hp}(t) as the provisional entry time t_{i_tmp} and the provisional exit time t_{o_tmp} of the railway vehicle 6 with respect to the bridge 5, respectively. Further, the measurement apparatus 1 calculates the provisional passing time t_{S_tmp} required for the railway vehicle 6 to pass the bridge 5 as the time of the difference between the provisional exit time t_{o_tmp} and the provisional entry time t_{i_tmp} as in Formula (2) described above.

Next, in a number-of-cars calculation step S30, the measurement apparatus 1 calculates the number of cars C_{T} of the railway vehicle 6 based on the acceleration data that is the observation data acquired in step S10. Specifically, the measurement apparatus 1 calculates the number of cars C_{T} of the railway vehicle 6 based on the provisional passing time t_{S_tmp} calculated in step S20 and the fundamental frequency f₀ using Formula (3) described above. Alternatively, the measurement apparatus 1 may calculate the number of cars C_{T} by counting the number of vibrations in the period between the provisional entry time t_{i_tmp} and the provisional exit time t_{o_tmp} in the displacement waveform u_{α_hp}(t) calculated in step S20. When the number of cars C_{T} is not changed by the railway vehicle 6 passing the bridge 5, the measurement apparatus 1 does not need to calculate the number of cars C_{T} based on the acceleration data output from the sensor 2, and thus, for example, the number of cars C_{T} may be provided in the environmental information. In this case, the measurement apparatus 1 may not perform the processing of the number-of-cars calculation step S30.

Next, in a deflection amount calculation step S40, the measurement apparatus 1 calculates the deflection amount T_{std}(t) of the bridge 5 caused by the railway vehicle 6 based on Formula (30) described above that is the approximate formula for the deflection of the bridge 5, the provisional entry time t_{i_tmp} and the provisional exit time t_{o_tmp} calculated in step S20, and the environmental information including the dimension of the railway vehicle 6 and the dimension of the bridge 5 which are created in advance. The measurement apparatus 1 calculates the deflection amount T_{std}(t) further based on the number of cars C_{T} calculated in step S30 or the number of cars C_{T} provided in the environmental information. Specifically, the measurement apparatus 1 calculates the deflection amount T_{std}(t) using Formulas (4) to (38) described above.

Next, in a correction value calculation step S50, the measurement apparatus 1 calculates, based on the displacement of the bridge 5 obtained based on the observation data and the deflection amount T_{std}(t) calculated in step S40, the entry time correction value t_{i_cor} for correcting an error of the provisional entry time t_{i_tmp} calculated in step S20 and the exit time correction value t_{o_cor} for correcting an error of the provisional exit time t_{o_tmp} calculated in step S20. An example of a procedure of the correction value calculation step S50 will be described later.

Next, in an entry and exit time calculation step S60, the measurement apparatus 1 calculates the entry time tᵢ of the railway vehicle 6 to the bridge 5 by adding the entry time correction value t_{i_cor} calculated in step S50 to the provisional entry time t_{i_tmp} calculated in step S20, and calculates the exit time tₒ of the railway vehicle 6 from the bridge 5 by adding the exit time correction value t_{o_cor} calculated in step S50 to the provisional exit time t_{o_tmp} calculated in step S20. The measurement apparatus 1 calculates the entry time tᵢ using Formula (39) described above and calculates the exit time tₒ using Formula (40) described above.

Next, in a passing speed calculation step S70, the measurement apparatus 1 treats the difference between the exit time tₒ and the entry time tᵢ calculated in step S60 as the passing time t_{S}, and calculates the passing speed of the railway vehicle 6 through the bridge 5. For example, the measurement apparatus 1 may calculate the average speed v_{avg} as the passing speed of the railway vehicle 6 using Formula (42) described above.

Next, in a measurement data output step S80, the measurement apparatus 1 outputs measurement data including the entry time tᵢ and the exit time tₒ calculated in step S60, the passing speed calculated in step S70, the displacement waveform u_{α_hp}(t) calculated in step S20, and the like to the monitoring apparatus 3. Specifically, the measurement apparatus 1 transmits the measurement data to the monitoring apparatus 3 via the communication network 4.

The measurement apparatus 1 repeats processing of steps S10 to S80 until measurement is ended in step S90.

FIG. 19 is a flowchart showing the example of the procedure of the correction value calculation step S50 in FIG. 18.

As shown in FIG. 19, first, in step S51, the measurement apparatus 1 performs high-pass filter processing on the deflection amount T_{std}(t) calculated in step S40 in FIG. 18 using a predetermined high-pass filter to calculate the deflection waveform u_{M_hp}(t). In the high-pass filter processing on the deflection amount T_{std}(t), the same high-pass filter as the high-pass filter used in the high-pass filter processing on the displacement u_{α}(t) in order to calculate the displacement waveform u_{α_hp}(t) in step S20 in FIG. 18 is used. Therefore, the cutoff frequency f_{C} of the high-pass filter is lower than the fundamental frequency f₀ of the vibration of the bridge 5 caused by the traveling of the railway vehicle 6 on the bridge 5. Therefore, the measurement apparatus 1 can calculate the deflection waveform u_{M_hp}(t) with reduced drift noise and a reduced offset error in a low-frequency range by the high-pass filter processing without reducing the fundamental frequency f₀ of the vibration of the bridge 5.

In step S52, the measurement apparatus 1 compares the displacement waveform u_{α_hp}(t) calculated in step S20 in FIG. 18 with the deflection waveform u_{M_hp}(t) calculated in step S51 to calculate the entry time correction value t_{i_cor} and the exit time correction value t_{o_cor}. Specifically, the measurement apparatus 1 calculates, as the entry time correction value t_{i_cor}, the difference between the time when the amplitude of the displacement waveform u_{α_hp}(t) first changes from positive to negative and the time when the amplitude of the deflection waveform u_{M_hp}(t) first changes from positive to negative in the period between the provisional entry time t_{i_tmp} and the provisional exit time t_{o_tmp}. The measurement apparatus 1 also calculates, as the exit time correction value t_{o_cor}, the difference between the time when the amplitude of the displacement waveform u_{α_hp}(t) last changes from negative to positive and the time when the amplitude of the deflection waveform u_{M_hp}(t) last changes from negative to positive in the period between the provisional entry time t_{i_tmp} and the provisional exit time t_{o_tmp}.

### 1-4. Configurations of Sensor, Measurement Apparatus, and Monitoring Apparatus

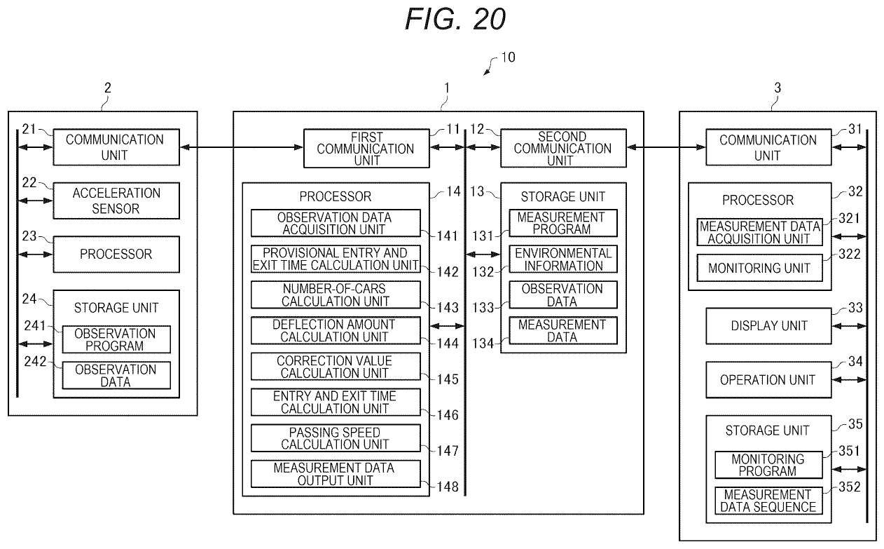

FIG. 20 shows a configuration example of the sensor 2, the measurement apparatus 1, and the monitoring apparatus 3. As shown in FIG. 20, the sensor 2 includes a communication unit 21, an acceleration sensor 22, a processor 23, and a storage unit 24.

The storage unit 24 is a memory that stores various programs, data, and the like for the processor 23 to perform calculation processing and control processing. The storage unit 24 also stores a program, data, and the like for the processor 23 to implement a predetermined application function.

The acceleration sensor 22 detects an acceleration generated in each axial direction of the three axes.

The processor 23 controls the acceleration sensor 22 by executing an observation program 241 stored in the storage unit 24, generates observation data 242 based on the acceleration detected by the acceleration sensor 22, and stores the generated observation data 242 in the storage unit 24. In the embodiment, the observation data 242 is acceleration data.

The communication unit 21 transmits the observation data 242 stored in the storage unit 24 to the measurement apparatus 1 under control of the processor 23.

As shown in FIG. 20, the measurement apparatus 1 includes a first communication unit 11, a second communication unit 12, a storage unit 13, and a processor 14.

The first communication unit 11 receives the observation data 242 from the sensor 2 and outputs the received observation data 242 to the processor 14.

The storage unit 13 is a memory that stores a program, data, and the like for the processor 14 to perform calculation processing and control processing. The storage unit 13 also stores various programs, data, and the like for the processor 14 to implement a predetermined application function. The processor 14 may receive various programs, data, and the like via the communication network 4 and store the programs, the data, and the like in the storage unit 13.

The processor 14 generates measurement data 134 based on the observation data 242 received by the first communication unit 11, and stores the generated measurement data 134 in the storage unit 13.

In the embodiment, by executing a measurement program 131 stored in the storage unit 13, the processor 14 functions as an observation data acquisition unit 141, a provisional entry and exit time calculation unit 142, a number-of-cars calculation unit 143, a deflection amount calculation unit 144, a correction value calculation unit 145, an entry and exit time calculation unit 146, a passing speed calculation unit 147, and a measurement data output unit 148. That is, the processor 14 includes the observation data acquisition unit 141, the provisional entry and exit time calculation unit 142, the number-of-cars calculation unit 143, the deflection amount calculation unit 144, the correction value calculation unit 145, the entry and exit time calculation unit 146, the passing speed calculation unit 147, and the measurement data output unit 148.

The observation data acquisition unit 141 acquires the observation data 242 received by the first communication unit 11 and stores the observation data 242 in the storage unit 13 as observation data 133. That is, the observation data acquisition unit 141 performs the processing of the observation data acquisition step S10 in FIG. 18. In the embodiment, the observation data 133 is acceleration data.

The provisional entry and exit time calculation unit 142 calculates the provisional entry time t_{i_tmp} and the provisional exit time t_{o_tmp} of the railway vehicle 6 with respect to the bridge 5 based on the displacement of the bridge 5 obtained based on the acceleration data that is the observation data 133 acquired by the observation data acquisition unit 141. Specifically, first, the provisional entry and exit time calculation unit 142 performs the fast Fourier transform processing on the acceleration α(t) provided in the acceleration data to calculate the power spectral density, and calculates the frequency of the peak having the lowest power spectral density as the fundamental frequency f₀. Next, the provisional entry and exit time calculation unit 142 performs the double integration on the acceleration α(t) to calculate the displacement u_{α}(t) as in Formula (1) described above. Next, the provisional entry and exit time calculation unit 142 performs the high-pass filter processing on the displacement u_{α}(t) using the predetermined high-pass filter to calculate the displacement waveform u_{α_hp}(t). The cutoff frequency f_{C} of the high-pass filter is lower than the fundamental frequency f₀ of the vibration of the bridge 5 caused by the traveling of the railway vehicle 6 on the bridge 5. The provisional entry and exit time calculation unit 142 calculates the time of the first peak and the time of the last peak of the vibration of the displacement waveform u_{α_hp}(t) as the provisional entry time t_{i_tmp} and the provisional exit time t_{o_tmp} of the railway vehicle 6 with respect to the bridge 5, respectively. Further, the provisional entry and exit time calculation unit 142 calculates the provisional passing time t_{S_tmp} required for the railway vehicle 6 to pass the bridge 5 as the time of the difference between the provisional exit time t_{o_tmp} and the provisional entry time t_{i_tmp} as in Formula (2) described above. That is, the provisional entry and exit time calculation unit 142 performs the processing of the provisional entry and exit time calculation step S20 in FIG. 18.

The number-of-cars calculation unit 143 calculates the number of cars C_{T} of the railway vehicle 6 based on the acceleration data that is the observation data 133 acquired by the observation data acquisition unit 141. Specifically, the number-of-cars calculation unit 143 calculates the number of cars C_{T} of the railway vehicle 6 based on the provisional passing time t_{S_tmp} calculated by the provisional entry and exit time calculation unit 142 and the fundamental frequency f₀ using Formula (3) described above. Alternatively, the number-of-cars calculation unit 143 may calculate the number of cars C_{T} by counting the number of vibrations in the period between the provisional entry time t_{i_tmp} and the provisional exit time t_{o_tmp} in the displacement waveform u_{α_hp}(t) calculated by the provisional entry and exit time calculation unit 142. That is, the number-of-cars calculation unit 143 performs the processing of the number-of-cars calculation step S30 in FIG. 18. When the number of cars C_{T} is not changed by the railway vehicle 6 passing the bridge 5, the number-of-cars calculation unit 143 does not need to calculate the number of cars C_{T} based on the acceleration data output from the sensor 2, and thus, for example, the number of cars C_{T} may be provided in environmental information 132. In this case, the processor 14 may not include the number-of-cars calculation unit 143.

The deflection amount calculation unit 144 calculates the deflection amount T_{std}(t) of the bridge 5 caused by the railway vehicle 6 based on Formula (30) described above that is the approximate formula for the deflection of the bridge 5, the provisional entry time t_{i_tmp} and the provisional exit time t_{o_tmp} calculated by the provisional entry and exit time calculation unit 142, and the environmental information 132 including the dimension of the railway vehicle 6 and the dimension of the bridge 5 which are created in advance. The deflection amount calculation unit 144 calculates the deflection amount T_{std}(t) further based on the number of cars C_{T} calculated by the number-of-cars calculation unit 143 or the number of cars C_{T} provided in the environmental information 132. Specifically, the deflection amount calculation unit 144 calculates the deflection amount T_{std}(t) using Formulas (4) to (38) described above. That is, the deflection amount calculation unit 144 performs the processing of the deflection amount calculation step S40 in FIG. 18.

The correction value calculation unit 145 calculates, based on the displacement of the bridge 5 obtained based on the observation data 133 and the deflection amount T_{std}(t) calculated by the deflection amount calculation unit 144, the entry time correction value t_{i_cor} for correcting the error of the provisional entry time t_{i_tmp} calculated by the provisional entry and exit time calculation unit 142 and the exit time correction value t_{o_cor} for correcting the error of the provisional exit time t_{o_tmp} calculated by the provisional entry and exit time calculation unit 142. Specifically, first, the correction value calculation unit 145 calculates the deflection waveform u_{M_hp}(t) by performing the high-pass filter processing on the deflection amount T_{std}(t) using the predetermined high-pass filter, and calculates the entry time correction value t_{i_cor} and the exit time correction value t_{o_cor} by comparing the displacement waveform u_{α_hp}(t) calculated by the provisional entry and exit time calculation unit 142 with the calculated deflection waveform u_{M_hp}(t). The correction value calculation unit 145 may calculate, as the entry time correction value t_{i_cor}, the difference between the time when the amplitude of the displacement waveform u_{α_hp}(t) first changes from positive to negative and the time when the amplitude of the deflection waveform u_{M_hp}(t) first changes from positive to negative in the period between the provisional entry time t_{i_tmp} and the provisional exit time t_{o_tmp}. The correction value calculation unit 145 may also calculate, as the exit time correction value t_{o_cor}, the difference between the time when the amplitude of the displacement waveform u_{M_hp}(t) last changes from negative to positive and the time when the amplitude of the deflection waveform u_{M_hp}(t) last changes from negative to positive in the period between the provisional entry time t_{i_tmp} and the provisional exit time t_{o_tmp}. That is, the correction value calculation unit 145 performs the processing of the correction value calculation step S50 in FIG. 18, specifically, the processing of steps S51 and S52 in FIG. 19.

The entry and exit time calculation unit 146 calculates the entry time tᵢ of the railway vehicle 6 to the bridge 5 by adding the entry time correction value t_{i_cor} calculated by the correction value calculation unit 145 to the provisional entry time t_{i_tmp} calculated by the provisional entry and exit time calculation unit 142, and calculates the exit time tₒ of the railway vehicle 6 from the bridge 5 by adding the exit time correction value t_{o_cor} calculated by the correction value calculation unit 145 to the provisional exit time t_{o_tmp} calculated by the provisional entry and exit time calculation unit 142. The entry and exit time calculation unit 146 calculates the entry time tᵢ using Formula (39) described above and calculates the exit time to using Formula (40) described above. That is, the entry and exit time calculation unit 146 performs the processing of the entry and exit time calculation step S60 in FIG. 18.

The passing speed calculation unit 147 treats the difference between the exit time tₒ and the entry time tᵢ calculated by the entry and exit time calculation unit 146 as the passing time t_{S}, and calculates the passing speed of the railway vehicle 6 through the bridge 5. For example, the passing speed calculation unit 147 may calculate the average speed v_{avg} as the passing speed of the railway vehicle 6 using Formula (42) described above. That is, the passing speed calculation unit 147 performs the processing of the passing speed calculation step S70 in FIG. 18.

The entry time tᵢ and the exit time tₒ calculated by the entry and exit time calculation unit 146, the passing speed calculated by the passing speed calculation unit 147, the displacement waveform u_{α_hp}(t) calculated by the provisional entry and exit time calculation unit 142, and the like are stored in the storage unit 13 as at least a part of the measurement data 134.

The measurement data output unit 148 reads the measurement data 134 stored in the storage unit 13 and outputs the measurement data 134 to the monitoring apparatus 3. Specifically, under control of the measurement data output unit 148, the second communication unit 12 transmits the measurement data 134 stored in the storage unit 13 to the monitoring apparatus 3 via the communication network 4. That is, the measurement data output unit 148 performs the processing of the measurement data output step S80 in FIG. 18.

In this way, the measurement program 131 is a program that causes the measurement apparatus 1, which is a computer, to execute each procedure in the flowchart shown in FIG. 18.

As shown in FIG. 20, the monitoring apparatus 3 includes a communication unit 31, a processor 32, a display unit 33, an operation unit 34, and a storage unit 35.

The communication unit 31 receives the measurement data 134 from the measurement apparatus 1 and outputs the received measurement data 134 to the processor 32.

The display unit 33 displays various types of information under control of the processor 32. The display unit 33 may be, for example, a liquid crystal display or an organic EL display. EL is an abbreviation for electro luminescence.

The operation unit 34 outputs operation data corresponding to an operation performed by a user to the processor 32. The operation unit 34 may be an input device such as a mouse, a keyboard, or a microphone.

The storage unit 35 is a memory that stores various programs, data, and the like for the processor 32 to perform calculation processing and control processing. The storage unit 35 also stores a program, data, and the like for the processor 32 to implement a predetermined application function.

The processor 32 acquires the measurement data 134 received by the communication unit 31, generates evaluation information by evaluating the passing speed of the railway vehicle 6 or a change over time in the displacement of the bridge 5 based on the acquired measurement data 134, and displays the generated evaluation information on the display unit 33.

In the embodiment, the processor 32 functions as a measurement data acquisition unit 321 and a monitoring unit 322 by executing a monitoring program 351 stored in the storage unit 35. That is, the processor 32 includes the measurement data acquisition unit 321 and the monitoring unit 322.

The measurement data acquisition unit 321 acquires the measurement data 134 received by the communication unit 31 and adds the acquired measurement data 134 to a measurement data sequence 352 stored in the storage unit 35.

The monitoring unit 322 evaluates the passing speed of the railway vehicle 6 based on the measurement data sequence 352 stored in the storage unit 35, and statistically evaluates the change over time in the displacement of the bridge 5. Then, the monitoring unit 322 generates the evaluation information indicating an evaluation result and displays the generated evaluation information on the display unit 33. Based on the evaluation information displayed on the display unit 33, the user can monitor the passing speed of the railway vehicle 6 and a state of the bridge 5.

The monitoring unit 322 may perform processing such as monitoring of the railway vehicle 6 and abnormality determination of the bridge 5 based on the measurement data sequence 352 stored in the storage unit 35.

The processor 32 transmits, based on the operation data output from the operation unit 34, information for adjusting an operation status of the measurement apparatus 1 or the sensor 2 to the measurement apparatus 1 via the communication unit 31. The operation status of the measurement apparatus 1 is adjusted based on the information received via the second communication unit 12. The measurement apparatus 1 transmits the information for adjusting the operation status of the sensor 2 received via the second communication unit 12 to the sensor 2 via the first communication unit 11. The operation status of the sensor 2 is adjusted based on the information received via the communication unit 21.

In the processors 14, 23, and 32, for example, functions of each part may be implemented using individual pieces of hardware, or the functions of each part may be implemented using integrated hardware. For example, the processors 14, 23, and 32 include hardware, and the hardware may include at least one of a circuit for processing a digital signal and a circuit for processing an analog signal. The processors 14, 23, and 32 may be a CPU, a GPU, a DSP, or the like. CPU is an abbreviation for a central processing unit, GPU is an abbreviation for a graphics processing unit, and DSP is an abbreviation for a digital signal processor. The processors 14, 23, and 32 may each be implemented as a custom IC such as an ASIC to implement the function of each unit, or the function of each unit may be implemented by a CPU and an ASIC. ASIC is an abbreviation for an application-specific integrated circuit, and IC is an abbreviation for an integrated circuit.

The storage units 13, 24, and 35 each include a recording medium, for example, various IC memories such as a ROM, a flash ROM, and a RAM, a hard disk, or a memory card. ROM is an abbreviation for a read-only memory, RAM is an abbreviation for a random access memory, and IC is an abbreviation for an integrated circuit. The storage units 13, 24, and 35 each include a non-volatile information storage device that is a computer-readable device or medium, and various programs, data, and the like may be stored in the information storage device. The information storage device may be an optical disk such as an optical disk DVD or CD, a hard disk drive, or various types of memories such as a card-type memory or a ROM.

Only one sensor 2 is shown in FIG. 20, and alternatively, a plurality of sensors 2 may each generate the observation data 242 and transmit the observation data 242 to the measurement apparatus 1. In this case, the measurement apparatus 1 receives a plurality of pieces of observation data 242 transmitted from the plurality of sensors 2, generates a plurality of pieces of measurement data 134, and transmits the plurality of pieces of measurement data 134 to the monitoring apparatus 3. The monitoring apparatus 3 receives the plurality of pieces of measurement data 134 transmitted from the measurement apparatus 1 and monitors the passing speed of the railway vehicle 6 and the state of the bridge 5 based on the received plurality of pieces of measurement data 134.

### 1-5. Functions and Effects

As described above, in the measurement method in the first embodiment, the measurement apparatus calculates the provisional entry time t_{i_tmp} and the provisional exit time t_{o_tmp} of the railway vehicle 6 with respect to the bridge 5 based on the displacement u_{α}(t) of the bridge 5 obtained based on the observation data, and calculates the theoretical deflection amount T_{std}(t) of the bridge 5 when the railway vehicle 6 enters the bridge 5 at the provisional entry time t_{i_tmp} and the railway vehicle 6 exits the bridge 5 at the provisional exit time t_{o_tmp} based on the environmental information and Formula (30) that is the approximate formula for the deflection of the bridge 5. Since the deflection amount T_{std}(t) includes no unnecessary vibration such as an environmental vibration, the measurement apparatus 1 can accurately calculate the entry time correction value t_{i_cor} for correcting the error of the provisional entry time t_{i_tmp} and the exit time correction value t_{o_cor} for correcting the error of the provisional exit time t_{o_tmp} based on the deflection amount T_{std}(t) and the displacement u_{α}(t) of the bridge 5 obtained based on the observation data. In particular, the measurement apparatus 1 can accurately calculate the entry time correction value t_{i_cor} and the exit time correction value t_{o_cor} by comparing the displacement waveform u_{α_hp}(t) and the deflection waveform u_{M_hp}(t) in each of which the drift noise and the offset error in the low-frequency range are reduced by the high-pass filter processing. Therefore, according to the measurement method in the first embodiment, the measurement apparatus 1 can accurately calculate the entry time tᵢ and the exit time tₒ of the railway vehicle 6 with respect to the bridge 5 using the entry time correction value t_{i_cor} and the exit time correction value t_{o_cor}.

According to the measurement method in the first embodiment, even when the number of cars C_{T} of the railway vehicle 6 traveling on the bridge 5 is unknown, the measurement apparatus 1 can calculate the number of cars C_{T} based on the observation data and accurately calculate the deflection amount T_{std}(t) of the bridge 5. Alternatively, when the number of cars C_{T} of the railway vehicle 6 traveling on the bridge 5 is determined in advance, the measurement apparatus 1 calculates the deflection amount T_{std}(t) of the bridge 5 using the number of cars C_{T} provided in the environmental information, thereby reducing a calculation load.

### 2. Second Embodiment

Hereinafter, in a second embodiment, the same components as those in the first embodiment will be denoted by the same reference signs, repetitive description as that in the first embodiment will be omitted or simplified, and contents different from those in the first embodiment will be mainly described.

In the second embodiment, the observation apparatus is not the acceleration sensor but a displacement gauge or an image measurement apparatus. The displacement gauge is, for example, a displacement measurement apparatus using a contact-type displacement gauge, a ring-type displacement gauge, a laser displacement gauge, a pressure-sensitive sensor, or an optical fiber, which detects displacement as a response to an action of each axle of the railway vehicle 6 on the observation point R. The image measurement apparatus detects the displacement as the response to the action of each axle of the railway vehicle 6 on the observation point R through image processing.

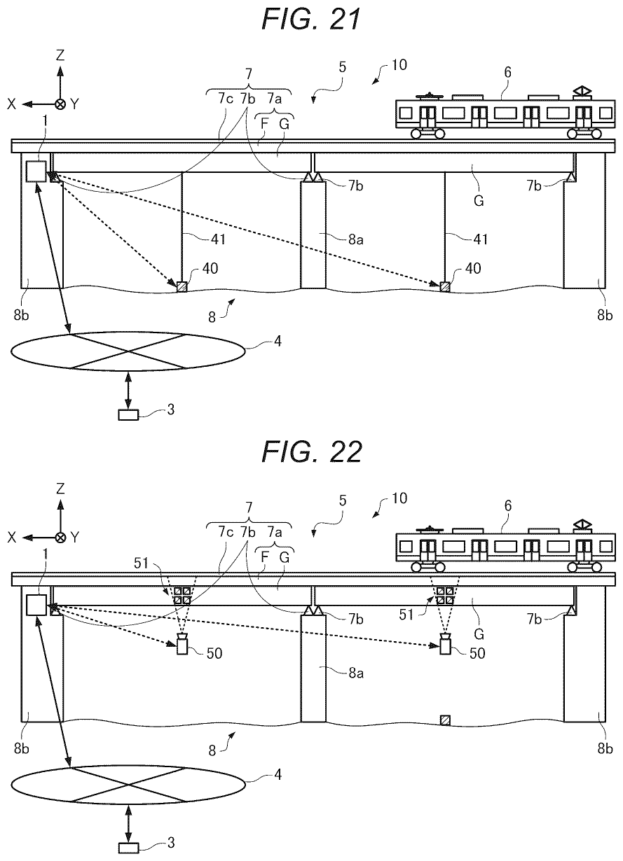

As an example, FIG. 21 shows a configuration example of the measurement system 10 using a ring-type displacement gauge as the observation apparatus. FIG. 22 shows a configuration example of the measurement system 10 using an image measurement apparatus as the observation apparatus. In FIGS. 21 and 22, the same components as those in FIG. 1 are denoted by the same reference signs, and description thereof will be omitted. In the measurement system 10 shown in FIG. 21, a piano wire 41 is fixed between an upper surface of a ring-type displacement gauge 40 and a lower surface of the main girder G directly above the ring-type displacement gauge 40. The ring-type displacement gauge 40 measures displacement of the piano wire 41 caused by deflection of the superstructure 7 and transmits measured displacement data to the measurement apparatus 1. The measurement apparatus 1 generates the measurement data 134 based on the displacement data transmitted from the ring-type displacement gauge 40. In the measurement system 10 shown in FIG. 22, a camera 50 transmits an image obtained by capturing an image of a target 51 provided at a side surface of the main girder G to the measurement apparatus 1. The measurement apparatus 1 processes the image transmitted from the camera 50, calculates displacement of the target 51 caused by the deflection of the superstructure 7 to generate displacement data, and generates the measurement data 134 based on the generated displacement data. In the example in FIG. 22, the measurement apparatus 1 serves as the image measurement apparatus to generate the displacement data, and alternatively, an image measurement apparatus (not shown) different from the measurement apparatus 1 may generate displacement data through image processing.

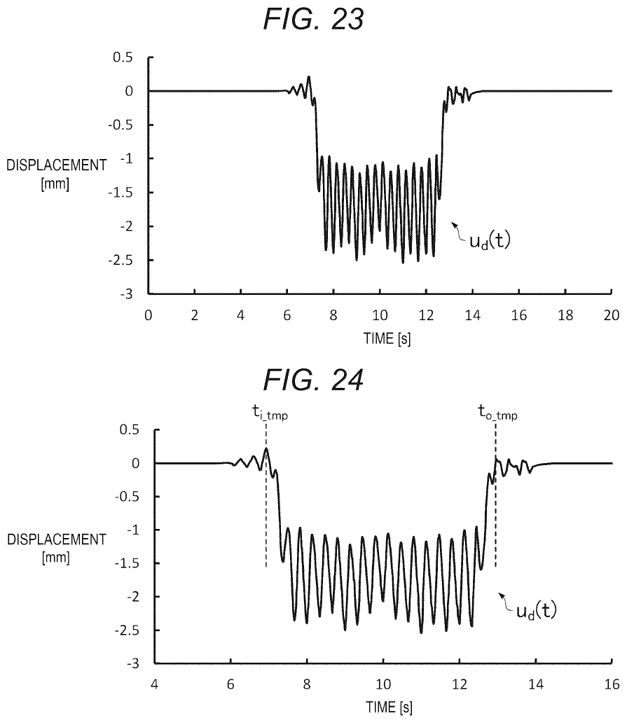

In the second embodiment, first, the measurement apparatus 1 calculates the provisional entry time t_{i_tmp} and the provisional exit time t_{o_tmp} of the railway vehicle 6 with respect to the bridge 5 based on displacement u_{d}(t) of the bridge 5 obtained based on the observation data output from the observation apparatus. The displacement u_{d}(t) is provided in the displacement data that is the observation data when the observation apparatus is the displacement gauge, and is obtained by processing the image that is the observation data when the observation apparatus is the image measurement apparatus. FIG. 23 shows an example of the displacement u_{d}(t).

Next, the measurement apparatus 1 calculates a time of a first peak and a time of a last peak of a vibration of a waveform of the displacement u_{d}(t) generated when the railway vehicle 6 passes the bridge 5 as the provisional entry time t_{i_tmp} and the provisional exit time t_{o_tmp} of the railway vehicle 6 with respect to the bridge 5, respectively. FIG. 24 shows an example of relationships between the displacement u_{d}(t) and each of the provisional entry time t_{i_tmp} and the provisional exit time t_{o_tmp}.

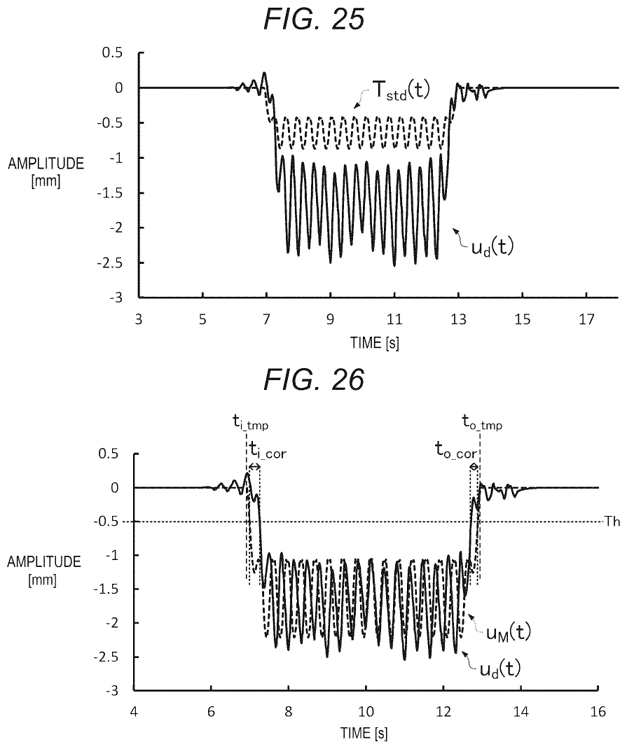

As in the first embodiment, the measurement apparatus 1 calculates the provisional passing time t_{S_tmp} and the number of cars C_{T} of the railway vehicle 6, and calculates the deflection amount T_{std}(t) caused by the railway vehicle 6 using Formulas (2) to (38) described above. As in the first embodiment, the number of cars C_{T} may be provided in the environmental information. In FIG. 25, the displacement u_{d}(t) shown in FIG. 24 is indicated by a solid line, and the deflection amount T_{std}(t) is indicated by a broken line. As shown in FIG. 25, the displacement u_{d}(t) and the deflection amount T_{std}(t) have different amplitudes.

The measurement apparatus 1 calculates an amplitude adjustment amount M using Formula (43) in order to adjust the amplitude of the deflection amount T_{std}(t) to match the amplitude of the displacement u_{d}(t). The amplitude adjustment amount M is a ratio of an average amplitude of the displacement u_{d}(t) to an average amplitude of the deflection amount T_{std}(t) from a time t1 to a time t2. The times t1 and t2 are any two times between the provisional entry time t_{i_tmp} and the provisional exit time t_{o_tmp}.

$$Math . 43$$

$$M = \frac{1}{{t}_{2} - {t}_{1}} {\int }_{t = {t}_{1}}^{{t}_{2}} {u}_{d} ( t ) dt / \frac{1}{{t}_{2} - {t}_{1}} {\int }_{t = {t}_{1}}^{{t}_{2}} {T}_{std} ( t ) dt \qquad ( 43 )$$

As in Formula (44), by multiplying the deflection amount T_{std}(t) by the amplitude adjustment amount M, a deflection waveform u_{M}(t) obtained by adjusting the amplitude of the deflection amount T_{std}(t) is obtained.

$$Math . 44$$

$${u}_{M} ( t ) = {MT}_{std} ( t ) \qquad ( 44 )$$

The measurement apparatus 1 calculates, as the entry time correction value t_{i_cor}, a difference between a time of a first intersection between any threshold Th and the displacement u_{d} (t) and a time of a first intersection between the threshold Th and the deflection waveform u_{M}(t) in the period between the provisional entry time t_{i_tmp} and the provisional exit time t_{o_tmp}. The measurement apparatus 1 calculates, as the exit time correction value t_{o_cor}, a difference between a time of a last intersection between the threshold value Th and the displacement u_{d}(t) and a time of a last intersection between the threshold value Th and the deflection waveform u_{M}(t) in the period between the provisional entry time t_{i_tmp} and the provisional exit time t_{o_tmp}. FIG. 26 shows relationships between each of the displacement u_{d}(t) shown in FIG. 25 and the deflection waveform u_{M}(t) shown in FIG. 25 obtained by adjusting the amplitude of the deflection amount T_{std}(t), and each of the entry time correction value t_{i_cor} and the exit time correction value t_{o_cor}. In the example in FIG. 26, the threshold Th is “−0.5”.

The measurement apparatus 1 calculates the entry time tᵢ by adding the provisional entry time t_{i_tmp} and the entry time correction value t_{i_cor} as in Formula (39) described above. The measurement apparatus 1 also calculates the exit time tₒ by adding the provisional exit time t_{o_tmp} and the exit time correction value t_{o_cor} as in Formula (40) described above.

Further, the measurement apparatus 1 may calculate the passing time t_{S} required for the railway vehicle 6 to pass the bridge 5 as the time of the difference between the exit time tₒ and the entry time tᵢ as in Formula (41) described above, and calculate the average speed v_{avg}, which is the passing speed of the railway vehicle 6 through the bridge 5, by Formula (42) described above using the calculated passing time t_{S}.

A flowchart showing an example of a procedure of a measurement method in the second embodiment is the same as FIG. 18, and thus illustration thereof is omitted. The processing of the observation data acquisition step S10, the provisional entry and exit time calculation step S20, the number-of-cars calculation step S30, the deflection amount calculation step S40, the entry and exit time calculation step S60, the passing speed calculation step S70, and the measurement data output step S80 in the measurement method in the second embodiment are the same as that in the first embodiment, and thus description thereof will be omitted.

As in the first embodiment, in the measurement method in the second embodiment, in the correction value calculation step S50, the measurement apparatus 1 calculates, based on the displacement of the bridge 5 obtained based on the observation data and the deflection amount T_{std}(t) calculated in step S40 in FIG. 18, the entry time correction value t_{i_cor} for correcting the error of the provisional entry time t_{i_tmp} calculated in step S20 in FIG. 18 and the exit time correction value t_{o_cor} for correcting the error of the provisional exit time t_{o_tmp} calculated in step S20 in FIG. 18. However, in the second embodiment, a procedure of the correction value calculation step S50 is different from that in the first embodiment.

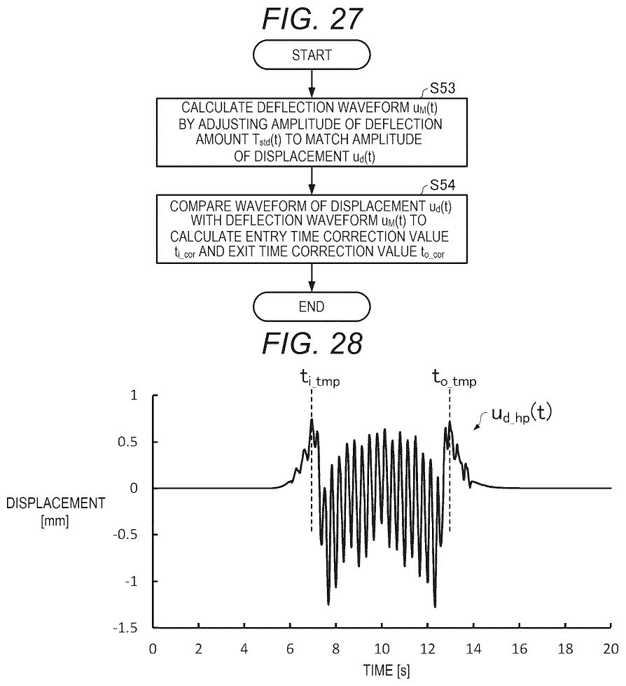

FIG. 27 is a flowchart showing an example of the procedure of the correction value calculation step S50 shown in FIG. 18 in the second embodiment.

As shown in FIG. 27, first, in step S53, the measurement apparatus 1 calculates the deflection waveform u_{M}(t) by adjusting the amplitude of the deflection amount T_{std}(t) calculated in step S40 in FIG. 18 to match the amplitude of the displacement u_{d}(t) of the bridge 5 obtained based on the observation data. The measurement apparatus 1 calculates the amplitude adjustment amount M using Formula (43) described above and calculates the deflection waveform u_{M}(t) by multiplying the deflection amount T_{std}(t) by the amplitude adjustment amount M as in Formula (44) described above.

In step S54, the measurement apparatus 1 compares the waveform of the displacement u_{d}(t) with the deflection waveform u_{M}(t) calculated in step S53 to calculate the entry time correction value t_{i_cor} and the exit time correction value t_{o_cor}. Specifically, the measurement apparatus 1 calculates, as the entry time correction value t_{i_cor}, the difference between the time of the first intersection between the any threshold Th and the displacement u_{d}(t) and the time of the first intersection between the threshold Th and the deflection waveform u_{M}(t) in the period between the provisional entry time t_{i_tmp} and the provisional exit time t_{o_tmp}. The measurement apparatus 1 calculates, as the exit time correction value t_{o_cor}, the difference between the time of the last intersection between the threshold value Th and the displacement u_{d}(t) and the time of the last intersection between the threshold value Th and the deflection waveform u_{M}(t) in the period between the provisional entry time t_{i_tmp} and the provisional exit time t_{o_tmp}.

Configurations of the measurement apparatus 1 and the monitoring apparatus 3 in the second embodiment are the same as those in FIG. 20, and a configuration of the sensor 2 in the second embodiment is the same as that in FIG. 20 except that a displacement detection unit or an image generation unit is provided instead of the acceleration sensor 22, and thus illustration thereof is omitted.

In the measurement apparatus 1 in the second embodiment, the correction value calculation unit 145 calculates, based on the displacement of the bridge 5 obtained based on the observation data 133 and the deflection amount T_{std}(t) calculated by the deflection amount calculation unit 144, the entry time correction value t_{i_cor} for correcting the error of the provisional entry time t_{i_tmp} calculated by the provisional entry and exit time calculation unit 142 and the exit time correction value t_{o_cor} for correcting the error of the provisional exit time t_{o_tmp} calculated by the provisional entry and exit time calculation unit 142. Specifically, first, the correction value calculation unit 145 calculates the deflection waveform u_{M}(t) by adjusting the amplitude of the deflection amount T_{std}(t) to match the amplitude of the displacement u_{d}(t) of the bridge 5 obtained based on the observation data 133. The correction value calculation unit 145 may calculate the amplitude adjustment amount M using Formula (43) described above and calculate the deflection waveform u_{M}(t) by multiplying the deflection amount T_{std}(t) by the amplitude adjustment amount M as in Formula (44) described above. The correction value calculation unit 145 compares the waveform of the displacement u_{d}(t) with the calculated deflection waveform u_{M}(t) to calculate the entry time correction value t_{i_cor} and the exit time correction value t_{o_cor}. The correction value calculation unit 145 may calculate, as the entry time correction value t_{i_cor}, the difference between the time of the first intersection between the any threshold Th and the displacement u_{d}(t) and the time of the first intersection between the threshold Th and the deflection waveform u_{M}(t) in the period between the provisional entry time t_{i_tmp} and the provisional exit time t_{o_tmp}. The measurement apparatus 1 may calculate, as the exit time correction value t_{o_cor}, the difference between the time of the last intersection between the threshold value Th and the displacement u_{d}(t) and the time of the last intersection between the threshold value Th and the deflection waveform u_{M}(t) in the period between the provisional entry time t_{i_tmp} and the provisional exit time t_{o_tmp}. That is, the correction value calculation unit 145 performs the processing of the correction value calculation step S50 in FIG. 18, specifically, the processing of steps S53 and S54 in FIG. 27.

Other functions of the measurement apparatus 1 in the second embodiment are the same as those in the first embodiment, and description thereof will be omitted. A function of the monitoring apparatus 3 in the second embodiment is the same as that in the first embodiment, and a function of the sensor 2 in the second embodiment is the same as that in the first embodiment except that displacement detection or image generation is performed instead of acceleration detection, and thus description thereof will be omitted.

As described above, in the measurement method in the second embodiment, since the observation apparatus is the displacement gauge or the image measurement apparatus, the measurement apparatus 1 does not need to perform processing such as integration on the observation data, and can acquire the displacement u_{d}(t) of the bridge 5 that includes no drift noise or offset error in the low-frequency range. Therefore, since the measurement apparatus 1 does not need to perform the high-pass filter processing on the displacement u_{d} (t) and the deflection amount T_{std}(t), the calculation load is reduced, and the entry time correction value t_{i_cor} and the exit time correction value t_{o_cor} can be accurately calculated by comparing the waveform of the displacement u_{d}(t) with the deflection waveform u_{M}(t) whose amplitude is adjusted. Therefore, according to the measurement method in the second embodiment, the measurement apparatus 1 can accurately calculate the entry time tᵢ and the exit time tₒ of the railway vehicle 6 with respect to the bridge 5 using the entry time correction value t_{i_cor} and the exit time correction value t_{o_cor}.

In addition, according to the measurement method in the second embodiment, the same effects as those of the measurement method in the first embodiment can be obtained.

### 3. Modifications

The disclosure is not limited to the embodiments, and various modifications can be made within the scope of the gist of the disclosure.

For example, in each of the above embodiments, each sensor 2 is provided at the main girder G of the superstructure 7, and alternatively, the sensor 2 may be provided at the surface of or inside the superstructure 7, at a lower surface of the deck slab F or the bridge pier 8a.

In the first embodiment, the sensor 2 that is the observation apparatus is the acceleration sensor, and alternatively, the observation apparatus may be the displacement gauge or the image measurement apparatus as in the second embodiment. In this case, in the provisional entry and exit time calculation step S20 in FIG. 18, first, the measurement apparatus 1 calculates the power spectral density by performing the fast Fourier transform processing on the displacement u_{d}(t) of the bridge 5 obtained based on the observation data output from the displacement gauge or the image measurement apparatus, and calculates the frequency of the peak having the lowest power spectral density as the fundamental frequency f₀. Next, the measurement apparatus 1 performs the high-pass filter processing on the displacement u_{d}(t) using the predetermined high-pass filter having the cutoff frequency f_{C} lower than the fundamental frequency f₀ to calculate the displacement waveform u_{d_hp}(t). The measurement apparatus 1 calculates a time of a first peak and a time of a last peak of a vibration of u_{d_hp}(t) as the provisional entry time t_{i_tmp} and the provisional exit time t_{o_tmp} of the railway vehicle 6 with respect to the bridge 5, respectively. FIG. 28 shows an example of relationships between the displacement waveform u_{d_hp}(t) and each of the provisional entry time t_{i_tmp} and the provisional exit time t_{o_tmp}.

In the correction value calculation step S50 in FIG. 18, the measurement apparatus 1 calculates, based on the displacement u_{d}(t) of the bridge 5 obtained based on the observation data and the deflection amount T_{std}(t) calculated in step S40 in FIG. 18, the entry time correction value t_{i_cor} for correcting the error of the provisional entry time t_{i_tmp} calculated in step S20 in FIG. 18 and the exit time correction value t_{o_cor} for correcting the error of the provisional exit time t_{o_tmp} calculated in step S20 in FIG. 18. Specifically, the measurement apparatus 1 calculates the deflection waveform u_{M_hp}(t) by performing the high-pass filter processing on the deflection amount T_{std}(t) using the same high-pass filter used in step S20. Then, the measurement apparatus 1 compares the displacement waveform u_{d_hp}(t) with the deflection waveform u_{M_hp}(t) to calculate the entry time correction value t_{i_cor} and the exit time correction value t_{o_cor}. The measurement apparatus 1 calculates, as the entry time correction value t_{i_cor}, a difference between a time when an amplitude of the displacement waveform u_{d_hp}(t) first changes from positive to negative and the time when the amplitude of the deflection waveform u_{M_hp}(t) first changes from positive to negative in the period between the provisional entry time t_{i_tmp} and the provisional exit time t_{o_tmp}. The measurement apparatus 1 also calculates, as the exit time correction value t_{o_cor}, a difference between a time when the amplitude of the displacement waveform u_{d_hp}(t) last changes from negative to positive and the time when the amplitude of the deflection waveform u_{M_hp}(t) last changes from negative to positive in the period between the provisional entry time t_{i_tmp} and the provisional exit time t_{o_tmp}. FIG. 29 shows relationships between each of the displacement waveform u_{d_hp}(t) shown in FIG. 28 and the deflection waveform u_{M_hp}(t) shown in FIG. 15, and each of the entry time correction value t_{i_cor} and the exit time correction value t_{o_cor}.

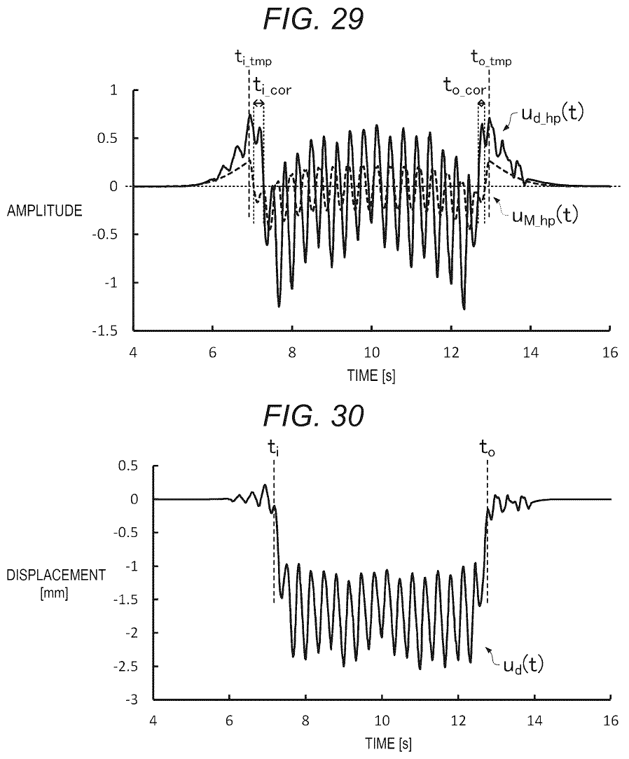

In the entry and exit time calculation step S60 in FIG. 18, the measurement apparatus 1 calculates the entry time tᵢ of the railway vehicle 6 to the bridge 5 by adding the entry time correction value t_{i_cor} calculated in step S50 in FIG. 18 to the provisional entry time t_{i_tmp} calculated in step S20 in FIG. 18, and calculates the exit time tₒ of the railway vehicle 6 from the bridge 5 by adding the exit time correction value t_{o_cor} calculated in step S50 in FIG. 18 to the provisional exit time t_{o_tmp} calculated in step S20 in FIG. 18. That is, the measurement apparatus 1 calculates the entry time tᵢ using Formula (39) described above and calculates the exit time tₒ using Formula (40) described above. FIG. 30 shows relationships between the displacement u_{d} (t) and each of the entry time tᵢ and the exit time tₒ. As shown in FIG. 30, the entry time tᵢ and the exit time tₒ at times different from a characteristic point of the displacement u_{d}(t) are accurately calculated.

The above embodiments and modifications are examples, and the disclosure is not limited thereto. For example, the embodiments and modifications may be combined as appropriate.

The disclosure includes configurations that are substantially identical to the configurations described in the embodiments, such as configurations where functions, methods, and results are the same, or configurations that achieve the same objects and effects. The disclosure includes configurations obtained by replacing non-essential portions of the configurations described in the embodiments. The disclosure includes configurations that can obtain the same functions and effects and configurations that can achieve the same object as the configurations described in the embodiments. The disclosure includes configurations obtained by adding known techniques to the configurations described in the embodiments.

The following contents are derived from the embodiments and the modifications described above.

An aspect of a measurement method includes:
an observation data acquisition step of acquiring observation data output from an observation apparatus that observes an observation point of a bridge, the observation data including a response to an action of a railway vehicle traveling on the bridge on the observation point;
a provisional entry and exit time calculation step of calculating, based on displacement of the bridge obtained based on the observation data, a provisional entry time and a provisional exit time of the railway vehicle with respect to the bridge;
a deflection amount calculation step of calculating a deflection amount of the bridge caused by the railway vehicle, based on an approximate formula for deflection of the bridge, the provisional entry time, the provisional exit time, and environmental information including a dimension of the railway vehicle and a dimension of the bridge which are created in advance;
a correction value calculation step of calculating, based on the displacement and the deflection amount, an entry time correction value for correcting an error of the provisional entry time and an exit time correction value for correcting an error of the provisional exit time; and
an entry and exit time calculation step of calculating an entry time of the railway vehicle to the bridge by adding the entry time correction value to the provisional entry time, and calculating an exit time of the railway vehicle from the bridge by adding the exit time correction value to the provisional exit time.

In this measurement method, the provisional entry time and the provisional exit time of the railway vehicle with respect to the bridge are calculated based on the displacement of the bridge obtained based on the observation data, and the theoretical deflection amount of the bridge when the railway vehicle enters the bridge at the provisional entry time and the railway vehicle exits the bridge at the provisional exit time is calculated based on the approximate formula for the deflection of the bridge and the environmental information. Since the deflection amount includes no unnecessary vibration such as an environmental vibration, it is possible to accurately calculate the entry time correction value for correcting the error of the provisional entry time and the exit time correction value for correcting the error of the provisional exit time based on the displacement and the deflection amount of the bridge obtained based on the observation data. Therefore, according to this measurement method, it is possible to accurately calculate the entry time and the exit time of the railway vehicle with respect to the bridge using the entry time correction value and the exit time correction value.

In an aspect of the measurement method,
the environmental information may include the number of cars of the railway vehicle.

According to this measurement method, the deflection amount of the bridge can be calculated using the number of cars in the environmental information without calculating the number of cars based on the observation data on a premise that the number of cars of the railway vehicle traveling on the bridge is determined in advance, and thus a calculation load is reduced.

An aspect of the measurement method further includes:
a number-of-cars calculation step of calculating, based on the observation data, the number of cars of the railway vehicle, in which
in the deflection amount calculation step, the deflection amount may be calculated based on the number of cars.

According to this measurement method, since the number of cars is calculated based on the observation data, it is possible to accurately calculate the deflection amount of the bridge even when the number of cars of the railway vehicle is unknown.

In an aspect of the measurement method,
in the provisional entry and exit time calculation step, a displacement waveform may be calculated by performing high-pass filter processing on the displacement using a predetermined high-pass filter, and
the correction value calculation step may include
   calculating a deflection waveform by performing high-pass filter processing on the deflection amount using the high-pass filter, and
   calculating the entry time correction value and the exit time correction value by comparing the displacement waveform with the deflection waveform.

According to this measurement method, it is possible to accurately calculate the entry time correction value and the exit time correction value by comparing the displacement waveform and the deflection waveform in each of which drift noise and an offset error in a low-frequency range are reduced by the high-pass filter processing.

In an aspect of the measurement method,
a cutoff frequency of the high-pass filter may be lower than a fundamental frequency of a vibration of the bridge caused by traveling of the railway vehicle on the bridge.

According to this measurement method, it is possible to calculate the displacement waveform and the deflection waveform in each of which the drift noise and the offset error in the low-frequency range are reduced by the high-pass filter processing without reducing the fundamental frequency of the vibration of the bridge.

In an aspect of the measurement method,
the correction value calculation step may include
   calculating a deflection waveform by adjusting an amplitude of the deflection amount to match an amplitude of the displacement, and
   calculating the entry time correction value and the exit time correction value by comparing a waveform of the displacement with the deflection waveform.

The displacement of the bridge obtained without performing processing such as integration on the observation data does not include the drift noise or the offset error in the low-frequency range. Therefore, according to this measurement method, since it is not necessary to perform the high-pass filter processing on the displacement and the deflection amount, the calculation load is reduced, and the entry time correction value and the exit time correction value can be accurately calculated by comparing the waveform of the displacement with the deflection waveform whose amplitude is adjusted.

In an aspect of the measurement method,
the observation apparatus may be an acceleration sensor, a displacement gauge, or an image measurement apparatus.

In an aspect of the measurement method,
the bridge may have a structure in which bridge weigh-in-motion (BWIM) functions.

An aspect of a measurement apparatus includes:
an observation data acquisition unit configured to acquire observation data output from an observation apparatus that observes an observation point of a bridge, the observation data including a response to an action of a railway vehicle traveling on the bridge on the observation point;
a provisional entry and exit time calculation unit configured to calculate, based on displacement of the bridge obtained based on the observation data, a provisional entry time and a provisional exit time of the railway vehicle with respect to the bridge;
a deflection amount calculation unit configured to calculate a deflection amount of the bridge caused by the railway vehicle, based on an approximate formula for deflection of the bridge, the provisional entry time, the provisional exit time, and environmental information including a dimension of the railway vehicle and a dimension of the bridge which are created in advance;
a correction value calculation unit configured to calculate, based on the displacement and the deflection amount, an entry time correction value for correcting an error of the provisional entry time and an exit time correction value for correcting an error of the provisional exit time; and
an entry and exit time calculation unit configured to calculate an entry time of the railway vehicle to the bridge by adding the entry time correction value to the provisional entry time, and to calculate an exit time of the railway vehicle from the bridge by adding the exit time correction value to the provisional exit time.

In this measurement apparatus, the provisional entry time and the provisional exit time of the railway vehicle with respect to the bridge are calculated based on the displacement of the bridge obtained based on the observation data, and the theoretical deflection amount of the bridge when the railway vehicle enters the bridge at the provisional entry time and the railway vehicle exits the bridge at the provisional exit time is calculated based on the approximate formula for the deflection of the bridge and the environmental information. Since the deflection amount includes no unnecessary vibration such as an environmental vibration, the measurement apparatus can accurately calculate the entry time correction value for correcting the error of the provisional entry time and the exit time correction value for correcting the error of the provisional exit time based on the displacement and the deflection amount of the bridge obtained based on the observation data. Therefore, according to this measurement apparatus, it is possible to accurately calculate the entry time and the exit time of the railway vehicle with respect to the bridge using the entry time correction value and the exit time correction value.

An aspect of a measurement system includes:
the aspect of the measurement apparatus; and
the observation apparatus.

An aspect of a non-transitory computer-readable storage medium storing a measurement program causes a computer to execute
an observation data acquisition step of acquiring observation data output from an observation apparatus that observes an observation point of a bridge, the observation data including a response to an action of a railway vehicle traveling on the bridge on the observation point;
a provisional entry and exit time calculation step of calculating, based on displacement of the bridge obtained based on the observation data, a provisional entry time and a provisional exit time of the railway vehicle with respect to the bridge;
a deflection amount calculation step of calculating a deflection amount of the bridge caused by the railway vehicle, based on an approximate formula for deflection of the bridge, the provisional entry time, the provisional exit time, and environmental information including a dimension of the railway vehicle and a dimension of the bridge which are created in advance;
a correction value calculation step of calculating, based on the displacement and the deflection amount, an entry time correction value for correcting an error of the provisional entry time and an exit time correction value for correcting an error of the provisional exit time; and
an entry and exit time calculation step of calculating an entry time of the railway vehicle to the bridge by adding the entry time correction value to the provisional entry time, and calculating an exit time of the railway vehicle from the bridge by adding the exit time correction value to the provisional exit time.

Using this measurement program, the computer calculates the provisional entry time and the provisional exit time of the railway vehicle with respect to the bridge based on the displacement of the bridge obtained based on the observation data, and calculates the theoretical deflection amount of the bridge when the railway vehicle enters the bridge at the provisional entry time and the railway vehicle exits the bridge at the provisional exit time based on the approximate formula for the deflection of the bridge and the environmental information. Since the deflection amount includes no unnecessary vibration such as an environmental vibration, the computer can accurately calculate the entry time correction value for correcting the error of the provisional entry time and the exit time correction value for correcting the error of the provisional exit time based on the displacement and the deflection amount of the bridge obtained based on the observation data. Therefore, according to this measurement program, the computer can accurately calculate the entry time and the exit time of the railway vehicle with respect to the bridge using the entry time correction value and the exit time correction value.

What is claimed is:

1. A measurement method comprising:
an observation data acquisition step of acquiring observation data output from an observation apparatus that observes an observation point of a bridge, the observation data including a response to an action of a railway vehicle traveling on the bridge on the observation point;
a provisional entry and exit time calculation step of calculating, based on displacement of the bridge obtained based on the observation data, a provisional entry time and a provisional exit time of the railway vehicle with respect to the bridge;
a deflection amount calculation step of calculating a deflection amount of the bridge caused by the railway vehicle, based on an approximate formula for deflection of the bridge, the provisional entry time, the provisional exit time, and environmental information including a dimension of the railway vehicle and a dimension of the bridge which are created in advance;
a correction value calculation step of calculating, based on the displacement and the deflection amount, an entry time correction value for correcting an error of the provisional entry time and an exit time correction value for correcting an error of the provisional exit time; and
an entry and exit time calculation step of calculating an entry time of the railway vehicle to the bridge by adding the entry time correction value to the provisional entry time, and calculating an exit time of the railway vehicle from the bridge by adding the exit time correction value to the provisional exit time.

2. The measurement method according to claim 1, wherein
the environmental information includes the number of cars of the railway vehicle.

3. The measurement method according to claim 1, further comprising:
a number-of-cars calculation step of calculating, based on the observation data, the number of cars of the railway vehicle, wherein
in the deflection amount calculation step, the deflection amount is calculated based on the number of cars.

4. The measurement method according to claim 1, wherein
in the provisional entry and exit time calculation step, a displacement waveform is calculated by performing high-pass filter processing on the displacement using a predetermined high-pass filter, and
the correction value calculation step includes
calculating a deflection waveform by performing high-pass filter processing on the deflection amount using the high-pass filter, and
calculating the entry time correction value and the exit time correction value by comparing the displacement waveform with the deflection waveform.

5. The measurement method according to claim 4, wherein
a cutoff frequency of the high-pass filter is lower than a fundamental frequency of a vibration of the bridge caused by traveling of the railway vehicle on the bridge.

6. The measurement method according to claim 1, wherein
the correction value calculation step includes
calculating a deflection waveform by adjusting an amplitude of the deflection amount to match an amplitude of the displacement, and
calculating the entry time correction value and the exit time correction value by comparing a waveform of the displacement with the deflection waveform.

7. The measurement method according to claim 1, wherein
the observation apparatus is an acceleration sensor, a displacement gauge, or an image measurement apparatus.

8. The measurement method according to claim 1, wherein
the bridge has a structure in which bridge weigh-in-motion (BWIM) functions.

9. A measurement apparatus comprising:
an observation data acquisition unit configured to acquire observation data output from an observation apparatus that observes an observation point of a bridge, the observation data including a response to an action of a railway vehicle traveling on the bridge on the observation point;
a provisional entry and exit time calculation unit configured to calculate, based on displacement of the bridge obtained based on the observation data, a provisional entry time and a provisional exit time of the railway vehicle with respect to the bridge;
a deflection amount calculation unit configured to calculate a deflection amount of the bridge caused by the railway vehicle, based on an approximate formula for deflection of the bridge, the provisional entry time, the provisional exit time, and environmental information including a dimension of the railway vehicle and a dimension of the bridge which are created in advance;
a correction value calculation unit configured to calculate, based on the displacement and the deflection amount, an entry time correction value for correcting an error of the provisional entry time and an exit time correction value for correcting an error of the provisional exit time; and
an entry and exit time calculation unit configured to calculate an entry time of the railway vehicle to the bridge by adding the entry time correction value to the provisional entry time, and to calculate an exit time of the railway vehicle from the bridge by adding the exit time correction value to the provisional exit time.

10. A measurement system comprising:
the measurement apparatus according to claim 9; and
the observation apparatus.

11. A non-transitory computer-readable storage medium storing a measurement program, the measurement program causing a computer to execute
an observation data acquisition step of acquiring observation data output from an observation apparatus that observes an observation point of a bridge, the observation data including a response to an action of a railway vehicle traveling on the bridge on the observation point;
a provisional entry and exit time calculation step of calculating, based on displacement of the bridge obtained based on the observation data, a provisional entry time and a provisional exit time of the railway vehicle with respect to the bridge;
a deflection amount calculation step of calculating a deflection amount of the bridge caused by the railway vehicle, based on an approximate formula for deflection of the bridge, the provisional entry time, the provisional exit time, and environmental information including a dimension of the railway vehicle and a dimension of the bridge which are created in advance;
a correction value calculation step of calculating, based on the displacement and the deflection amount, an entry time correction value for correcting an error of the provisional entry time and an exit time correction value for correcting an error of the provisional exit time; and
an entry and exit time calculation step of calculating an entry time of the railway vehicle to the bridge by adding the entry time correction value to the provisional entry time, and calculating an exit time of the railway vehicle from the bridge by adding the exit time correction value to the provisional exit time.
